(19) United States
(12) Patent Application Publication
(10) Pub. No.: US 2007/0011357 A1
(43) Pub. Date: Jan. 11, 2007

(54) RECORDING AND REPRODUCTION APPARATUS

(75) Inventors: Shigeaki WATANABE, Mount Laurel, NJ (US); Yoshio KAWAKAMI, Osaka (JP); Takaaki SUZUKI, Lawrenceville, NJ (US)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/422,206

(22) Filed: Jun. 5, 2006

Related U.S. Application Data
(60) Provisional application No. 60/687,624, filed on Jun. 6, 2005.
(60) Provisional application No. 60/751,374, filed on Dec. 19, 2005.

(51) Int. Cl. G06F 15/16

(52) U.S. Cl. 709/249

(57) ABSTRACT

Conventionally, in a broadcast recording and reproduction apparatus that executes an application program in synchronization with service reproduction, only a single service is recorded even if the application program can be synchronized with a new service and continuously executed after a service switch. Therefore, when the service is switched during reproduction of an already-recorded service, the application program cannot perform its original operation. The present invention maintains normal operation of the application program by referring to synchronization information of the application program when the service that includes the application program is recorded, and simultaneously recording a service to which it is possible to switch.

### CROSS REFERENCE TO RELATED APPLICATIONS

This application claims the benefit of U.S. Provisional Application No. 60/687,624, filed Jun. 6, 2005, and U.S. Provisional Application No. 60/751,374, filed Dec. 19, 2005, the contents of which are herein incorporated by reference in their entirety.

### BACKGROUND OF THE INVENTION

(1) Field of the Invention

The present invention relates to a broadcast recording and reproduction apparatus which accumulates a content and reproduces the accumulated content. In particular, the present invention relates to a setup for receiving a content made up of data such as video, audio, and a program that are mutually synchronized, multiplexed with a broadcast wave, and sent, in which the broadcast wave is received and the video, audio, and data is accumulated, as well as a setup for reproducing the content while maintaining synchronization between the video/audio and the data such as a program.

(2) Description of the Related Art

Various content is included in a broadcast wave sent from a broadcast station. Aside from video and audio used in a normal TV show, there are cases where data is included in the content. There are several methods for sending the data, which can be roughly divided into a method of sending the data chronologically and a method of repeatedly sending the data per set interval. In the former method of sending the data chronologically, for example, data that continues over the course of time is sent in sequential order. This method is suitable for sending large amounts of data over a long period of time, but there is a drawback in that data that could not be received due to timing of the send cannot be received again.

On the other hand, in the later method of repeatedly sending the data at a set interval, the same data is repeatedly sent any number of times during a fixed period. This method has an advantage in that during the period when the same data is being sent, any one of the repeatedly-sent pieces of data can be received, and thus the timing of receiving is not limited. Data broadcast, represented by BML, and file sending through DSM-CC data carousel are examples of this method. It is unknown, particularly in broadcast, when a recipient will select a channel and commence reception. In the method of sending the data chronologically, when the start of reception falls behind the timing of the sending and acquisition of data fails, the data cannot be re-acquired. Therefore, when sending data such as an application program along with video and audio in the broadcast wave, the method of repeatedly sending the data per set interval is favorable.

At present, specifications for receiving a broadcast wave that includes video, audio, and an application program and executing the application program in synchronization with video and audio, as in the above method, have been developed and are in operation. It is possible to receive the sent application program, load the application program into a terminal, and implement various extra functions by executing the application program, rather than simply viewing the video and audio. This method for sending the application program and loading the application program into the terminal is also called “downloading”.

For example, a specification called Digital Video Broadcasting-Multimedia Home Platform (DVB-MHP) ETSI ES 201 812 v1.1.1 (2003-12) has been developed in Europe, and operations according to this specification have already commenced. In addition, Open Cable Application Platform (OCAP) OC-SP-OCAP1.0-I14-050119 specification, which provides the same arrangement in the cable broadcast environment, is being developed in the United States, and actual operations are set to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I01-040524 specification, which is aimed at adding a function for recording and reproducing the content in the OCAP specification, is being developed. With this specification, the video, audio, and the Java application program synchronized thereto and executed, which are sent as a cable television broadcast, are recorded as the content, and furthermore, are reproduced in the same manner as when the recorded content are directly reproduced from the broadcast wave. The application program is reproduced in synchronization with the video and audio, in the same manner as direct reproduction from the broadcast wave.

Moreover, with OCAP-DVR, trick-play of the content is realized by recording broadcast content to a high-speed randomly accessible storage medium, such as a hard disk, a semiconductor memory, and the like. Here, the trick-play refers to functions for reproducing the content at an arbitrary speed, from an arbitrary position, and so on, such as fast-forward, reverse, slow-motion, pause, skip, and the like.

With OCAP-DVR, the application program loaded into the terminal from the broadcast wave can control the recording and trick-play of the content. In other words, APIs for recording and trick play are so provided in the terminal, and the Java application program controls each function by calling those APIs.

In OCAP-DVR, the video, audio, and the application program synchronized thereto and executed are collectively defined as a service. When a broadcast receiving terminal reproduces a service, the application is executed in synchronization with the reproduction of the video and audio. Normally, in the case where switching of the service occurs, the service to be switched to contains a different application program, and thus the application program executed up until then is terminated. However, here, in the case where the same application program is contained within a plurality of services, it is possible to continuously execute that application program within a new service even if a service switch occurs.

For example, a video A, an audio A, and an application program A are included in a service A, and a video B, an audio B, and the application program A are included in a different service B. The application program A is written in the program code for switching between the service A and the service B. The application program A is executed while the service A is being reproduced; after this, the aforementioned program code is executed, and even if the service switches and the service B is reproduced, the application program A is continuously executed. Note that with OCAP-DVR, it is possible to cause the application program A to terminate in the case of a service switch by appropriately setting a flag within synchronization information of the application program.

With the recording function of OCAP-DVR, it is possible to record a broadcasted service. However, with OCAP-DVR, a single service or a channel identifier is specified when specifying the service to be recorded; therefore, a malfunction occurs in the case where an application program for two or more services is reproduced. In other words, to use the aforementioned description, the service B is not recorded in the case where the service A is specified to be recorded. Thus, when the program code written in the application program A for switching from the service A to the service B is executed during reproduction of the service A, the service B cannot be reproduced, and an abnormal state occurs.

In view of this, an object of the present invention is to provide a recording and reproduction apparatus and a recording and reproduction method in which an abnormal state does not occur even when a service switch actually occurs, by referring to synchronization information of the application program when the service that includes the application program is recorded, and simultaneously recording a service that may be switched to.

### SUMMARY OF THE INVENTION

To achieve the abovementioned object, a recording and reproduction apparatus of the present invention includes: a receiving unit that receives plural services, each including video information, audio information, a program, synchronization information for synchronizing the video information and the audio information with the program, and service element identification information for identifying the video information, audio information, program, and synchronization information; a recording unit that records, into a recording medium, a specified predetermined service, from among the received plural services; a reproduction unit that reproduces video information and audio information included in the received predetermined service or the predetermined service recorded in the recording medium; and a program execution unit that executes a program included in the received predetermined service or the predetermined service recorded in the recording medium, and the recording and reproduction apparatus reproduces the video information and the audio information included in the predetermined service recorded in the recording medium in synchronization with the program included in the predetermined service, by executing the program included in the predetermined service in accordance with the synchronization information; reacquires the service element identification information corresponding to the specified predetermined service among the received plural services in the case where an update of the synchronization information or the service element identification information occurs while the recording unit is recording the predetermined service; and isolates the specified predetermined service based on the acquired service element identification information, and causes the recording unit to record the isolated service.

Accordingly, it is possible to prevent an abnormal state from occurring even when a service switch actually occurs by referring to synchronization information of the application program when the service that includes the application program is recorded, and simultaneously recording a service to which it is possible to switch.

Furthermore, the recording and reproduction apparatus may reacquire the service element identification information corresponding to the specified predetermined service among the received plural services in the case where an update of the synchronization information or the service element identification information occurs while said recording unit is recording, and may isolate the specified predetermined service based on the acquired service element identification information, and causes said recording unit to record video information, audio information, a program, the synchronization information, and the service element identification information included in the isolated service.

Moreover, the recording and reproduction apparatus may reacquire the service element identification information corresponding to the specified predetermined service among the received plural services in the case where an update of the synchronization information or the service element identification information occurs while said recording unit is recording, and may isolate the specified predetermined service based on the acquired service element identification information, and causes said recording unit to record a transport stream corresponding to the isolated service.

Further still, a program included in a specified first service that is to be recorded may also be included in a second service; the synchronization information may include continuous execution information indicating whether or not it is possible to continue executing the program included in the first service when the first service is switched, during reproduction, to the second service, and the second service is reproduced; and the recording and reproduction apparatus may isolate, as the predetermined service, the second service in addition to the specified first service, based on the acquired service element identification information, and cause said recording unit to record the isolated service, in the case where the continuous execution information included in the synchronization information corresponding to the program included in the first service indicates that it is possible to continue executing the program even when the second service is switched to and the second service is reproduced.

Accordingly, in the case where the program is of a type that is continuously executable even it a service switch occurs, the second service is also recorded in the recording medium, and therefore the program does not fall into a state in which it is not continuously executable at the time of a service switch.

Furthermore, the recording and reproduction apparatus may isolate, as the predetermined service, the second service in addition to the specified first service, based on the acquired service element identification information, and cause the recording unit to record the isolated service, only in the case where simultaneous recording of the first service and the second service can be allowed.

Moreover, the recording and reproduction apparatus according to the present invention includes: a receiving unit that receives plural services, each including video information, audio information, a program, synchronization information for synchronizing the video information and the audio information with the program, and service element identification information for identifying the video information, audio information, program, and synchronization information; a recording unit that records, into a recording medium, a specified first service among the received plural services; a reproduction unit that reproduces video information and audio information included in the received first service or the first service recorded in the recording medium; and a program execution unit that executes a program included in the received first service or the first service recorded in the recording medium, and the recording and reproduction apparatus reproduces the video information and the audio information included in the first service recorded in the recording medium in synchronization with the program included in the first service, by executing the program included in the first service in accordance with the synchronization information; the program included in the first service that is specified to be recorded is also included in a second service; the synchronization information includes continuous execution information indicating whether or not it is possible to continue executing the program included in the first service when the first service is switched, during reproduction, to the second service, and the second service is reproduced; and the recording and reproduction apparatus isolates, as the predetermined service, the second service in addition to the specified first service, based on the acquired service element identification information, and causes the recording unit to record the isolated service, in the case where the continuous execution information included in the synchronization information corresponding to the program included in the first service indicates that it is possible to continue executing the program even when the second service is switched to and the second service is reproduced.

Accordingly, it is possible to prevent an abnormal state from occurring even when a service switch actually occurs by referring to synchronization information of the application program when the service that includes the application program is recorded, and simultaneously recording a service to which it is possible to switch.

Furthermore, the program included in the first service that is specified to be recorded may also be included in a second service; the synchronization information may include continuous execution information indicating whether or not it is possible to continue executing the program included in the first service when the first service is switched, during reproduction, to the second service, and the second service is reproduced; and the recording and reproduction apparatus may isolate, as the predetermined service, the second service in addition to the specified first service, based on the acquired service element identification information, and cause the recording unit to record a transport stream corresponding to the isolated service, in the case where the continuous execution information included in the synchronization information corresponding to the program included in the first service indicates that it is possible to continue executing the program even when the second service is switched to and the second service is reproduced.

Moreover, the recording and reproduction apparatus may isolate, as the predetermined service, the second service in addition to the specified first service, based on the acquired service element identification information, and cause said recording unit to record the transport stream corresponding to the isolated service, only in the case where simultaneous recording of the first service and the second service can be allowed.

Further still, the recording unit may convert a file format of a service into another format, in the case of recording a service into the recording medium, and record a validity period of the file along with the service.

Accordingly, for example, the program and synchronization information are recorded as a file; therefore, space can be saved in the recording medium, and the program does not fall into a state in which continuous execution is not possible at the time of a service switch.

Furthermore, the recording unit may recommence recording of the service each time the synchronization information or the service element identification information is updated.

Note that the present invention can be implemented not only as the above-mentioned recording and reproduction apparatus but also as a recording and reproduction method, a program for the method and a storage medium for storing the program.

### FURTHER INFORMATION ABOUT TECHNICAL BACKGROUND TO THIS APPLICATION

The disclosures of U.S. Provisional Application No. 60/687,624, filed Jun. 6, 2005, and U.S. Provisional Application No. 60/751,374, filed Dec. 19, 2005 including specification, drawings and claims are incorporated herein by reference in their entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is one example of how to use a frequency band used in communications between a system on the broadcast system side and a terminal apparatus, in a cable television system according to the present invention;

FIG. 3 is one example of how to use a frequency band used in communications between a system on the broadcast system side and a terminal apparatus, in a cable television system according to the present invention;

FIG. 4 is one example of how to use a frequency band used in communications between a system on the broadcast system side and a terminal apparatus, in a cable television system according to the present invention;

FIG. 5 is a configuration diagram of a TS packet predefined by MPEG-2 specifications;

FIG. 6 is a schematic diagram of an MPEG-2 transport stream;

FIG. 7 is an example of division when a PES packet predefined by MPEG-2 specifications is carried in TS packets;

FIG. 8 is an example of division when an MPEG-2 section predefined by MPEG-2 specifications is transmitted using a TS packet;

FIG. 9 is a configuration diagram of an MPEG-2 section predefined by MPEG-2 specifications;

FIG. 10 is an example of use of an MPEG-2 section predefined by MPEG-2 specifications;

FIG. 11 is an example of use of a PMT predefined by MPEG-2 specifications;

FIG. 12 is an example of use of a PAT predefined by MPEG-2 specifications;

FIG. 13 is a configuration example of a hardware configuration of a broadcast recording and reproduction apparatus according to the present invention;

FIG. 14 is an example of a front panel of an input unit 1310 in a hardware configuration of a terminal apparatus 1200 according to the present invention;

FIG. 15 is an example of a device connection at the time of recording, in the recording and reproduction apparatus according to the present invention;

FIG. 16 is an example of a device connection at the time of reproduction, in the recording and reproduction apparatus according to the present invention;

FIG. 17 is a diagram showing a structure of the program stored in a terminal apparatus according to the present invention;

FIG. 18 is an example of an EPG executed by a terminal apparatus according to the present invention;

FIG. 19 is an example of an EPG executed by a terminal apparatus according to the present invention;

FIG. 20 is an example of information stored in the secondary storage unit according to the present invention;

FIG. 21 is an example of a record information management table according to the present invention;

FIG. 22 is a schematic diagram showing details of AIT prescribed by the DVB-MHP standard according to the present invention;

FIG. 23 is a schematic diagram showing a file system sent in DSMCC format according to the present invention;

FIG. 24 is a diagram showing a structure of the program stored in a terminal apparatus according to the present invention;

FIG. 25 is an example of a device connection at the time of recording, in the recording and reproduction apparatus according to the present invention;

FIG. 26 is a configuration example of a hardware configuration of a broadcast recording and reproduction apparatus according to the present invention;

FIG. 27 is an example of a device connection at the time of recording, in the recording and reproduction apparatus according to the present invention;

FIG. 28 is an example of a device connection at the time of reproduction, in the recording and reproduction apparatus according to the present invention;

FIG. 29 is an example of a record information management table according to the present invention FIG. 30 is a schematic diagram showing extension details of AIT according to the present invention;

FIG. 31 is a flowchart of a recording processing according to the present invention;

FIG. 32 is a flowchart of a recording processing according to the present invention;

FIG. 33 is a flowchart of a recording processing according to the present invention;

FIG. 34 is a flowchart of a recording processing according to the present invention;

FIG. 35 is a flowchart of a recording processing according to the present invention;

FIG. 36 is a flowchart of a recording processing according to the present invention;

FIG. 37 is a flowchart of a recording processing according to the present invention;

FIG. 38 is a flowchart of a recording processing according to the present invention; and

FIG. 39 is a flowchart of a recording processing according to the present invention.

### DESCRIPTION OF THE PREFERRED EMBODIMENTS

The recording and reproduction apparatus according to the present invention records a content made up of video, audio, a program, and synchronization information for synchronizing the video, the audio, and the program, the synchronization information including continuously executable information which indicates that execution of the program can be continued even when the content is switched to another content; the apparatus includes: a storage medium for storing the content, and a content storage unit which stores, in the storage medium, all the content included within a content transport medium in the case where the continuously executable information indicates that the execution of the program can be continued, and stores, in said storage medium, only a specified content in other cases.

Accordingly, when the program is a type that can be continuously executed even when the content is switched to another content, all of the content within the content transport medium is stored in the storage medium, and therefore the program does not fall into a state where continuous execution is not possible at the time of switching to another content.

In addition, the content recording and reproduction apparatus includes a storage allowance unit holding unit that holds a detachable storage allowance unit which allows a plurality of contents to be stored in the storage medium; the content storage unit inquires, in the case where the continuously executable information indicates that the execution of the program can be continued, whether or not storing all the content included within the content transport medium is allowed, and stores, in the storage medium, all the content included within the content transport medium in the case of allowance, and stores, in the storage medium, only the specified content in other cases.

Accordingly, actual storage occurs after allowance to store, in the storage medium, all the content within the content transport medium; therefore, recording is performed taking into consideration the capacity of the storage medium, and the program also does not fall into a state where continuous execution is not possible at the time of switching to another content.

Moreover, the content recording and reproduction apparatus includes a content selection unit holding unit that holds a detachable content selection unit for selecting which content to store in the storage medium, and the content storage unit is stores, in the storage medium, only the content which the content selection unit has judged to be recorded based on information that can specify all the content included within the content transport medium.

Accordingly, rather than storing all the content within the content transport stream, only the selected content is stored in the storage medium; therefore, it is possible to conserve space within the storage medium, and the program also does not fall into a state where continuous execution is not possible at the time of switching to another content.

In addition, the content recording and reproduction apparatus includes a content selection unit holding unit that holds a detachable content selection unit for selecting which content to store in said storage medium; in the case where the content selection unit has not specified the content to be recorded based on the information in that can specify all the content included within the content transport medium, the content storage unit inquires, in the case where the continuously executable information indicates that the execution of the program can be continued, whether or not storing all the content included within the content transport medium is allowed, and stores, in the storage medium, all the content included within the content transport medium in the case of allowance, and stores, in the storage medium, only the specified content in other cases.

Accordingly, it is possible to specify whether to store, in the storage medium, all the content within the content transport stream or only the selected content; therefore, it is possible to conserve space within the storage medium, and the program also does not fall into a state where continuous execution is not possible at the time of switching to another content.

In addition, the synchronization information includes continuously executable information which indicates that execution of the program can be continued even when the content is switched to another content, and content specifying information for specifying another content that the program requires, and the recording and reproduction apparatus includes a content storage unit that stores, in the storage medium, the content specified by the content specifying information in the case where the continuously executable information indicates that the execution of the program can be continued, and stores, in the storage medium, only specified content in other cases.

Accordingly, it is possible to specify an other content that the program requires; therefore, it is possible to conserve space within the storage medium, and the program also does not fall into a state where continuous execution is not possible at the time of switching to another content.

Moreover, the content storage unit inquires, in the case where the continuously executable information indicates that the program can be continuously executed, whether storing the content specified by the content specifying information is allowed, and stores, in the storage medium, the content specified by the content specifying information in the case of allowance, and stores, in the storage medium, only the specified content in other cases.

Accordingly, it is possible to specify an other content that the program requires; therefore, it is possible to record taking into consideration the conservation of space within the storage medium, and the program also does not fall into a state where continuous execution is not possible at the time of switching to another content.

Furthermore, in addition to being possible to specify an other content that the program requires, it is also possible to select the content to actually be stored; therefore, it is possible to conserve space within the storage medium, and the program also does not fall into a state where continuous execution is not possible at the time of switching to another content.

Moreover, in the case where the content selection unit has not specified the content to be recorded based on the content specifying information, the content storage unit inquires, in the case where the continuously executable information indicates that the execution of the program can be continued, whether storing the content specified by the content specifying information is allowed, and stores, in the storage medium, the content specified by the content specifying information in the case of allowance, and stores, in the storage medium, only the specified content in other cases.

Accordingly, upon specifying an other content that the program requires, it is also possible to select the content to actually be stored, and even in the case of not selecting the content, it is possible to record taking into consideration the conservation of space within the storage medium, and the program also does not fall into a state where continuous execution is not possible at the time of switching to another content.

Moreover, the content transport medium is stored directly when the content storage unit stores, in the storage medium, all the content included within the content transport medium.

Accordingly, the content transport stream itself is stored when storing all the content within the content transport stream; therefore, the structure can be simplified, and the program also does not fall into a state where continuous execution is not possible at the time of switching to another content.

Moreover, the content storage unit stores, in the storage medium, all of contents which have, as a constituent element, synchronization information with a value in which at least one of the pieces of continuously executable information indicates that the execution of the program can be continued.

Accordingly, the content within the content transport stream that is considered necessary is stored in the storage medium upon specifying the program of the type that can be continuously executed even when the content changes to a different content, and therefore the program does not fall into a state where continuous execution is not possible at the time of switching to another content.

Moreover, the content storage unit inquires, in the case where the continuously executable information within the synchronization information that has specified content as the constituent element indicates that the execution of the program can be continued, whether storing, in the storage medium, all of the contents which have, as a constituent element, the synchronization information with a value in which at least one of the piece of continuously executable information indicates that the execution of the program can be continued is allowed, and stores, in the storage medium, all of the contents which have, as a constituent element, the synchronization information with a value in which at least one of the piece of continuously executable information indicates that the execution of the program can be continued in the case of allowance, and stores, in said storage medium, only the specified content in other cases.

Accordingly, actual storage occurs after the allowance regarding whether or not to store, in the storage medium, the content within the content transport stream that is considered necessary; therefore, it is possible to record taking into consideration the conservation of space within the storage medium, and the program also does not fall into a state where continuous execution is not possible at the time of switching to another content.

Moreover, the content storage unit stores, in the storage medium, only the content which the content selection unit judged as to be recorded based on information that can specify the contents which have, as a constituent element, the synchronization information with a value in which at least one of the piece of continuously executable information indicates that the execution of the program can be continued.

Accordingly, rather than storing all the content within the content transport stream that is considered necessary, only the selected content is stored in the storage medium, and therefore it is possible to conserve space within the storage medium, and the program also does not fall into a state where continuous execution is not possible at the time of switching to another content.

Moreover, in the case where the content selection unit has not specified the content to be recorded based on the information that can specify the contents which have, as a constituent element, the synchronization information with a value in which at least one of the piece of continuously executable information indicates that the execution of the program can be continued, the content storage unit inquires, in the case where the continuously executable information indicates that execution of the program can be continued, whether or not storing, in said storage medium, all of the contents which have, as a constituent element, the synchronization information with a value in which at least one of the piece of continuously executable information indicates that the execution of the program can be continued is allowed, and stores, in the storage medium, all of the contents which have, as a constituent element, the synchronization information with a value in which at least one of the piece of continuously executable information indicates that the execution of the program can be continued in the case of allowance, and stores, in the storage medium, only the specified content in other cases.

Accordingly, it is possible to specify whether to store all the content within the content transport stream that is considered necessary or only the selected content in the storage medium, and therefore it is possible to conserve space within the storage medium, and the program also does not fail into a state where continuous execution is not possible at the time of switching to another content.

Moreover, the video and audio are stored in stream format, and the program and synchronization information are stored in a file format extracted from the stream, when the content storage unit carries out storing in the storage medium.

Accordingly, the program and synchronization information are stored as files, and therefore it is possible to conserve space within the storage medium, and the program also does not fall into a state where continuous execution is not possible at the time of switching to another content.

### First Embodiment

Hereafter, an apparatus and a method according to the first embodiment of the present invention are described with reference to the drawings. The present invention is aimed at recording and reproduction of a content sent and received with an arbitrary medium; however, in the present embodiment, a cable television broadcast system is described as an example. In the cable television broadcast system, a broadcast recording and reproduction apparatus (recording and reproduction apparatus), as in the present invention, is generally called a terminal apparatus.

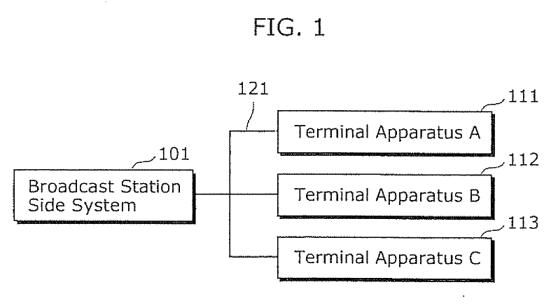

FIG. 1 is a block diagram showing a relationship of apparatuses that make up a broadcast system; the broadcast system is made up of a broadcast station side system (head-end) 101, a terminal apparatus A111, a terminal apparatus B112, and a terminal apparatus C113. A coupling 121 between the broadcast station side system and each terminal apparatus is, in the cable system, a wired coupling such as a coaxial cable, a fiber-optic cable, and the like. In FIG. 1, one broadcast station side system is coupled with three terminal apparatuses, but the number of terminal apparatuses is arbitrary.

The broadcast station side system 101 sends information such as video/audio/data for data broadcast in a broadcast signal to a plurality of terminal apparatuses. The broadcast signal is sent using a frequency within a frequency band set by an operational regulation of the broadcast system, the laws of a country/region in which the broadcast system is operated, and so on.

With the cable system in the present embodiment, the frequency band used in broadcast signal transmission is divided into the data details and transmission direction (inbound, outbound) and applied.

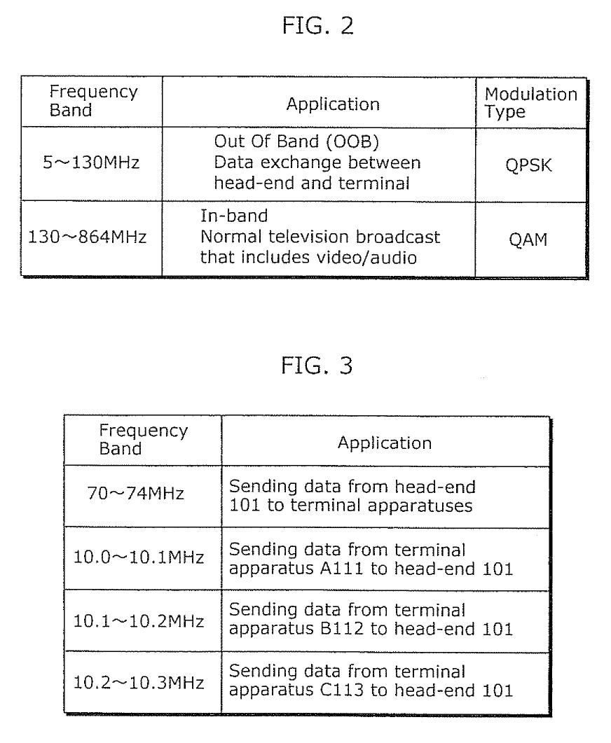

FIG. 2 is a chart showing one example of the division of the frequency band. The frequency band is roughly divided into two types: Out Of Band (abbr. OOB) and In-Band. 5 MHz to 130 MHz is assigned as OOB, and is mainly used in inbound/outbound data exchange between the broadcast station side system 101 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation type is used with OOB, and QAM64 or QAM256 modulation type is used with In-Band. Modulation type technology is generally known and of little concern to the present invention, and therefore detailed descriptions are omitted.

FIG. 3 is one example of a more detailed use of the OOB frequency band. 70 MHz to 74 MHz is used in outbound data sending from the broadcast station side system 101, and all of the terminal apparatus A111, the terminal apparatus B112, and the terminal apparatus C113 receive the same data from the broadcast station side system 101. On the other hand, 10.0 MHz to 10.1 MHz is used in inbound data sending from the terminal apparatus A111 to the broadcast station side system 101; 10.1 MHz to 10.2 MHz is used in inbound data sending from the terminal apparatus B112 to the broadcast station side system 101; and 10.2 MHz to 10.3 MHz is used in inbound data sending from the terminal apparatus C113 to the broadcast station side system 101. Through this, it is possible to independently send data unique to each terminal apparatus from each terminal apparatus A111, B112, and C113 to the broadcast station side system 101.

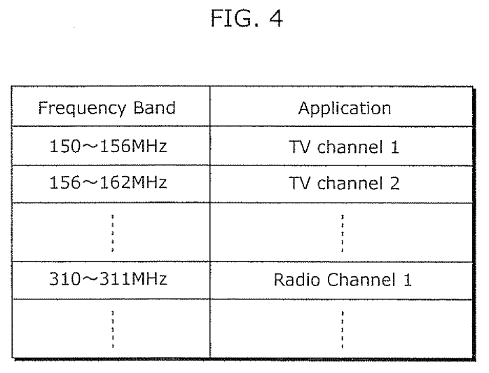

FIG. 4 is one example of use of an In-Band frequency band. 150 MHz to 156 MHz and 156 MHz to 162 MHz are assigned to a TV channel 1 and a TV channel 2 respectively, and thereafter, TV channels are assigned at 6 MHz intervals. Radio channels are assigned in 1 MHz units from 310 MHz on Each of these channels may be used as analog broadcast or as digital broadcast. Digital broadcast is sent in TS packet format under MPEG-2 specifications, and it is also possible to send data for various data broadcast and TV show organization information for configuring an EPG, in addition to audio and video.

The broadcast station side system 101 uses the frequency bands described above to send an appropriate broadcast signal to the terminal apparatuses, and therefore has a QPSK modulation unit, a QAM modulation unit, and so on. In addition, the broadcast station side system 101 has a QPSK demodulator for receiving data from the terminal apparatuses. Moreover, the broadcast station side system 101 can be thought of as having various devices related to the modulation units and the demodulation unit. However, the present invention relates mainly to the terminal apparatuses, and therefore detailed descriptions are omitted.

The terminal apparatuses A111, B112, and C113 have a QAM demodulation unit and a QPSK demodulation unit in order to receive and reproduce a broadcast signal from the broadcast station side system 101. In addition, each terminal apparatus has a QSPK modulation unit in order to send data, which is unique to each terminal apparatus, to the broadcast station side system 101. In the present invention, the terminal apparatuses are broadcast recording and reproduction apparatuses, and detailed configurations are described later.

The broadcast station side system 101 modulates an MPEG-2 transport stream and transmits the stream within the broadcast signal. A terminal apparatus receives the broadcast signal, demodulates and reproduces the MPEG-2 transport stream, and from the stream, extracts and uses necessary information. In order to describe a device function and connection structure present in the terminal apparatus, the structure of the MPEG2 transport stream is first described in a simple manner.

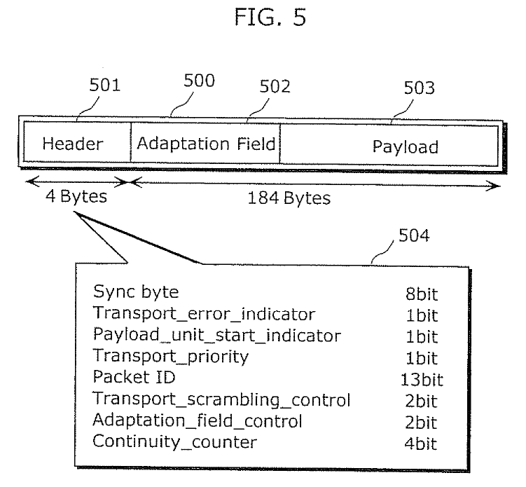

FIG. 5 is a diagram showing the structure of a TS packet. A TS packet 500 has a length of 188 bytes, and is composed of a header 501, an adaptation field 502, and a payload 503. The header 501 holds control information of the TS packet, has a length of 4 bytes, and is structured as shown in 504. In the header 501 there is a field denoted as “Packet ID” (hereafter, PID), and the TS packet is identified through the value of this PID. The adaptation field 502 holds additional information such as time information The adaptation field 502 is not prerequisite, and there are cases where the adaptation field 502 is not present. The payload 503 holds information carried in the TS packet, such as video, audio, and data broadcast data.

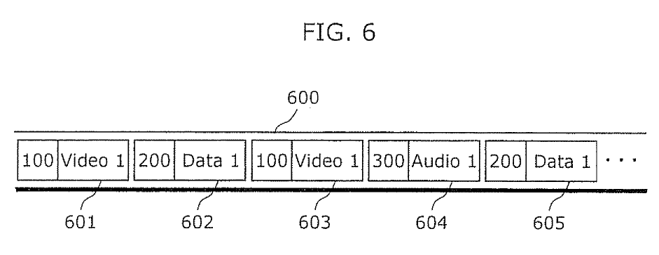

FIG. 6 is a schematic diagram of the MPEG-2 transport stream. The TS packet holds various information in the payload, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a series in sequence is called multiplexing. An MPEG2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV show organization information, by receiving multiplexed TS packets and extracting, per PID, the information that the TS packet holds. In FIG. 6, the TS packet 601 and the TS packet 603 each carry information regarding the video 1, and the TS packet 602 and the TS packet 605 each carry information regarding the data 1.

Here, description is given regarding a format of each type of data contained in the payload.

Video and audio are expressed by a format called a Packetized Elementary Stream (PES) packet. The PES packet includes video information or audio information of a certain time period, and by receiving the PES packet, the broadcast recording and reproduction apparatus can output the video and audio information contained in that PES packet to a screen and speaker. The broadcast station transmits the PES packets without pause, and therefore it is possible for the broadcast recording and reproduction apparatus to continuously reproduce the video and audio without pause. When the PES packet is actually transmitted, the PES packet is divided and stored in the payloads of a plurality of TS packets in the case where the PES packet has a size larger than the payload of one TS packet.

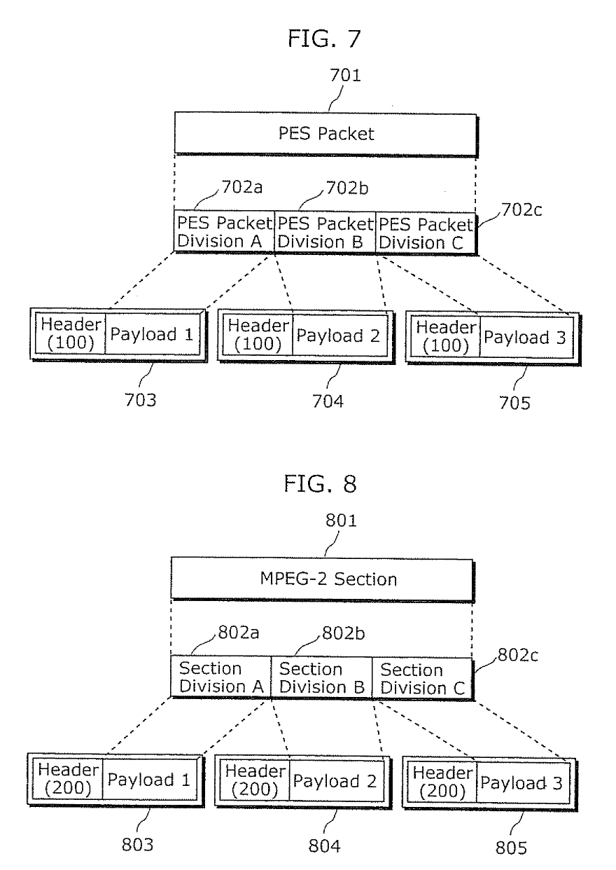

FIG. 7 shows an example of division when a PES packet is transmitted. A PES packet 701 is too large to be stored and carried in a payload of a single TS packet, and therefore the PES packet 701 is divided into a PES packet division A 702a, a PES packet division B 702b, and a PES packet division C 702c, and is carried in three TS packets 703 to 705 which have identical PIDs. In actuality, the video and audio is obtained as an elementary stream (ES) that is obtained by concatenating data contained in the payloads of a plurality of PES packets. The format of this elementary stream is digitalized video and audio, such as defined by the MPEG-2 Video standard, the MPEG-1 and 2 Audio standard, and the like.

On the other hand, information such as the TV show organization information and data used for data broadcast is expressed using a format called an MPEG-2 section. When the MPEG-2 section is actually transmitted, the MPEG-2 section is divided and stored in the payloads of a plurality of TS packets in the case where the MPEG-2 section has a size larger than the payload of one TS packet.

FIG. 8 shows an example of division when the MPEG-2 section is transmitted. As an MPEG-2 section 801 is too large to be stored and carried in a payload of a single TS packet, the MPEG-2 section 801 is divided into a section division A 802a, a section division B 802b, and a section division C 802c, and is carried in three TS packets 803 to 805 which have identical PIDs.

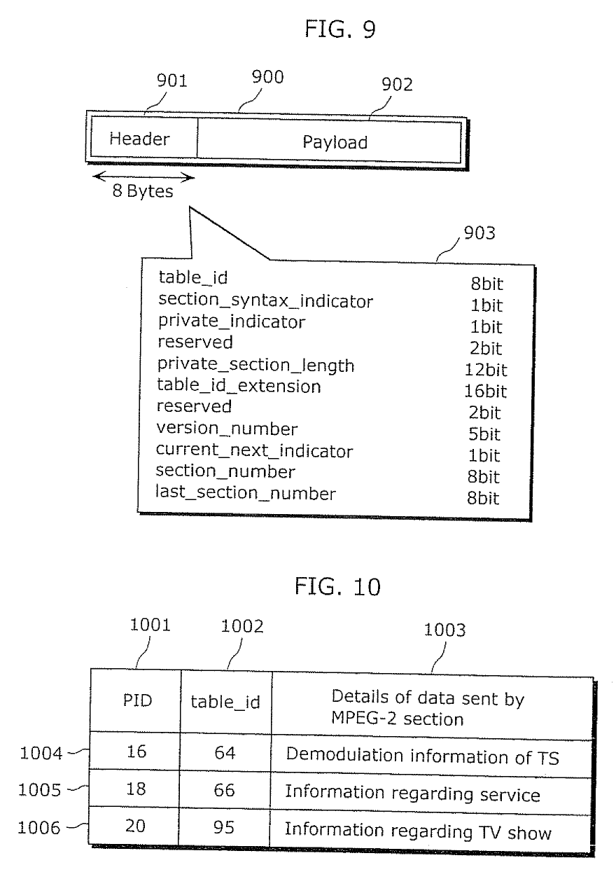

FIG. 9 expresses a structure of the MPEG-2 section. An MPEG-2 section 900 is configured of a header 901 and a payload 902. The header 901 holds control information of the MPEG-2 section, That configuration is expressed by a header configuration 903. The payload 902 holds data carried in the MPEG-2 section 900. A table_id present in the header configuration 903 expresses the type of the MPEG-2 section, and a table_id_extension is an extension identifier used when further distinguishing between MPEG-2 sections with an identical table_id.

The case where the TV show organization information is transmitted, as in FIG. 10, can be given as an example of use of the MPEG-2 section. In this example, as written in a row 1004, information necessary for demodulation of the broadcast signal is written in the MPEG-2 section that has a table_id of 64 in the header configuration 903, and this MPEG-2 section is further carried in a TS packet with a PID of 16 assigned.

The PES format does not exist in the case of the MPEG-2 section. For that reason, the elementary stream (ES) is the concatenation of the payloads of TS packets identified by identical PIDs within the MPEG-2 transport stream. For example, in FIG. 8, the TS packets 803 to 805, in which the MPEG-2 section 801 is divided and carried, all are identified with the PID of 200. It can be said that this is an ES which carries the MPEG-2 section 801.

A concept called a program further exists in the MPEG-2 transport stream. The program is expressed as a collection of ESs, and is used in the case where handling a plurality of ESs all together is desirable. When the program is used, it is possible to handle video/audio, as well as accompanying data broadcast data, all together. For example, in the case of simultaneously handling the video/audio to be reproduced, by grouping the video ES and the audio ES as a program, it can be seen that the broadcast recording and reproduction apparatus should simultaneously reproduce these two ESs as one TV show.

To express the program, two tables, called a Program Map Table (PMT) and a Program Association Table (PAT), are used in MPEG-2. Detailed descriptions can be found in the specifications of ISO/IEC 13818-1, “MPEG-2 Systems”. The PMT and the PAT are briefly described hereafter.

The PMT is a table which includes the number of programs in the MPEG-2 transport stream. The PMT is configured as an MPEG-2 section, and has a table_id of 2. The PMT holds a program number used in identifying the program and additional information of the program, as well as information regarding an ES belonging to the program.

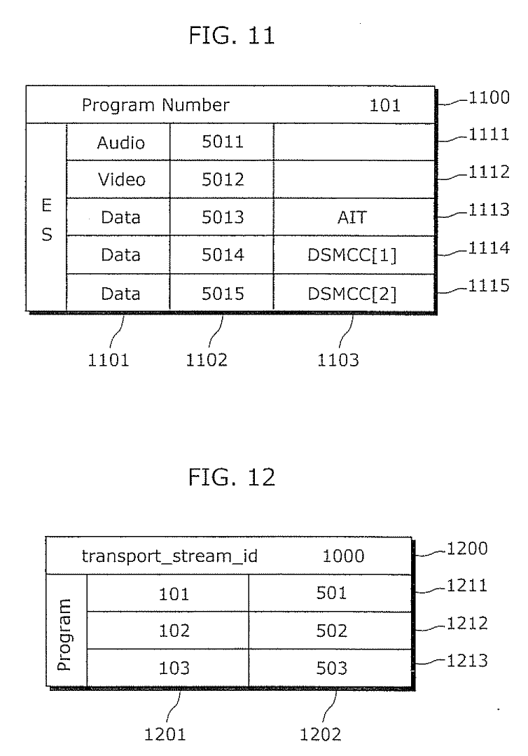

An example of the PMT is given in FIG. 11. 1100 is a program number. The program number is assigned uniquely to programs in the same transport stream, and is used in identifying the PMT. Rows 1111 to 1114 express information regarding individual ESs. A column 1101 is a type of ES, in which “video”, “audio”, “data”, and so on are specified. A column 1102 is the PID of the TS packets that make up the ES. A column 1103 is additional information regarding the ES. For example, the ES shown in row 1111 is an audio ES, and is carried by TS packets with a PID of 5011.

The PAT is a table, of which only one is present, in the MPEG-2 transport stream. The PAT is configured as an MPEG-2 section, has a table_id of 0, and is carried by a TS packet with a PID of 0. The PAT holds a transport_stream_id used in identification of the MPEG-2 transport stream, and information regarding all PMTs that represent a program existing in the MPEG-2 transport stream.

An example of the PAT is given in FIG. 12. 1200 is a transport_stream_id. The transport_stream_id is used in identifying the MPEG-2 transport stream. Rows 1211 to 1213 express information regarding the program. A column 1201 is the program number. A column 1202 is the PID of the TS packet which sends the PMT that corresponds to the program. For example, the PMT of the program shown in row 1211 has a program number of 101, and the corresponding PMT is carried in the TS packet with a PID of 501.

In the case where the terminal apparatus reproduces a certain program, the terminal apparatus uses the PAT and the PMT and specifies the video and audio that make up a program, and reproduces that video and audio. For example, in regards to the MPEG-2 transport stream that carries the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”.

The PAT is searched for a program with the program number “101”, and row 1211 is obtained. From row 1211, the PID “501”, of the TS packet which carries the PMT of the program with a program number “101”, is obtained. Next, the PMT transmitted as the MPEG-2 section with a table_id of “2” is acquired from the TS packet with the PID of “501”. Row 1111, which is audio ES information, and row 1112, which is video ES information, are obtained from the PMT. A PID “5011” of the TS packet which carries the audio ES is obtained from row 1111. In addition, a PID “5012” of the TS packet which carries the video ES is obtained from row 1112. Next, an audio PES packet is acquired from the TS packet with a PID “5011”, and a video PES packet is acquired from the TS packet with a PID of “5012”. Through this, it is possible to acquire the video and audio ES packets to be reproduced, and the video and audio that make up the program number 101 can be reproduced.

Note that there are cases where the MPEG-2 transport stream is scrambled. This is a setup called a conditional access system. For example, by scrambling the PES packets which carry a certain video/audio, only specified viewers who can descramble them are able to view that video and audio. In order to descramble and view the video and audio, a viewer must descramble the video and audio using a device called a descrambler. For example, in an OCAP-compatible terminal apparatus, a card-form adapter with an internal descrambler is used. A cable television operator distributes an adapter configured to be able to descramble a specified program to each viewer, and the viewer inserts that adapter into the terminal apparatus. Upon doing so, the adapter descrambles the specified program based on descrambling information such as a descrambling key and contract information of each contract holder. A method of descrambling, a method of obtaining the descrambling key, and the like depend on the adapter, and have no influence on the implementation of the present invention.

Thus far, simple descriptions regarding the MPEG-2 specifications have been; hereafter, detailed definitions of terminology are given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called “service” and the latter is called simply “program”. Furthermore, concerning the latter, a “program” particularly written in the Java language is called a “Java program”.

Description has been given regarding several kinds of general information specified in the MPEG-2 specifications according to the present invention. Hereafter, the broadcast recording and reproduction terminal used in the present embodiment is described in detail.

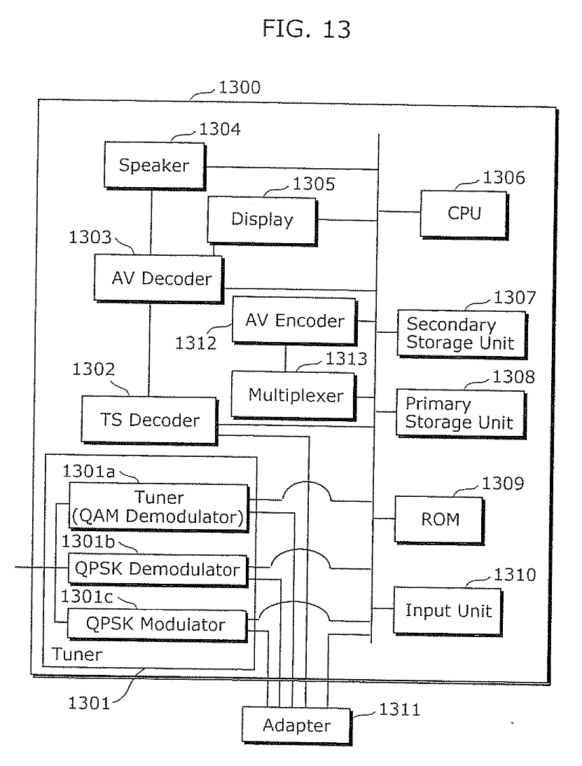

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is the broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; and a multiplexer (MPEG-2 Transport Stream Multiplexer or the like) 1313. Note that the present embodiment is obtained by expanding a broadcast recording and reproduction terminal implemented by the OCAP-DVR specifications, and the specific hardware configuration is nearly identical to that required by the OCAP-DVR specifications.

The tuner 1301 is a device which demodulates a broadcast signal modulated and transmitted from the broadcast station side system 101, in accordance with tuning information such as a frequency prescribed by the CPU 1306. The tuner 1301 includes: a QAM demodulator 1301a that internally demodulates an In-band signal; a QPSK demodulator 1301b that demodulates an Out-of-band signal; and a QPSK modulator 1301c that performs modulation. An MPEG-2 transport stream obtained as a result when the QAM demodulator 1301a of the tuner 1301 demodulates the In-band signal passes through the adapter that has a descrambling function, and is sent to the TS decoder 1302. The TS decoder 1302 is a device which has a function to segregate PES packets and MPEG-2 sections which comply with specified conditions from the MPEG-2 transport stream, based on a PID, a section filter condition, and so on prescribed by the CPU 1306.

This segregation function is called packet filtering. Two types of filter devices, which are a PID filter and a section filter, are included within the TS decoder. Details on filtering are given later. Input of the MPEG-2 transport stream to the TS decoder is performed by plural types of constituent elements. In the case where a broadcast is received and a service is reproduced without recording, the MPEG-2 transport stream which the adapter 1311 outputs is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306, which receives an instruction from software.

The PES packets of the video and audio which the TS decoder 1302 segregated are outputted to the AV decoder 1303. In addition, the MPEG-2 section segregated by the TS decoder 1302 is transferred to the primary storage unit 1308 through Direct Memory Access (DMA), and is used by a program and the like executed by the CPU 1306.

The AV decoder 1303 is a device with a function to decode the encoded video ES and audio ES. The AV decoder fetches the ES from the PES packet that carries the audio and video information sent from the TS decoder, and decodes the ES. An audio signal and a video signal obtained through the decoding performed by the AV decoder 1303 are sent to the speaker 1304 and the display 1305 at the time of service reproduction, but are sent to the AV encoder 1312 at the time of service recording. Which output route to take is controlled by the CPU 1306, which receives an instruction from software.

The speaker 1304 reproduces audio outputted from the AV decoder 1303.

The display 1305 reproduces video outputted from the AV decoder 1303.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU executes a program downloaded from a broadcast signal or a network and held in the secondary storage unit 1307. The tuner 1301, TS decoder 1302, AV decoder 1303, speaker 1304, display 1305, secondary storage unit 1307, primary storage unit 1308, ROM 1309, and input unit 1310 are controlled in accordance with the directions of the executed program. In addition, the CPU 1306 is capable of controlling the adapter 1311 by communicating not only with devices present within the terminal apparatus 1300, but with devices within the adapter 1311.

The secondary storage unit 1307 is a memory apparatus, the memory of which is not deleted even if the power supply to the device is interrupted; for example, a nonvolatile memory such as a FLASH-ROM, a Hard Disk Drive (HDD), a rewritable media such as a CD-R and a DVD-R. The secondary storage unit 1307 saves information based on an instruction from the CPU 1306.

The primary storage unit 1308 is a device which has a function for temporarily saving information in accordance with an instruction from the CPU 1306, a DMA-transfer capable device, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

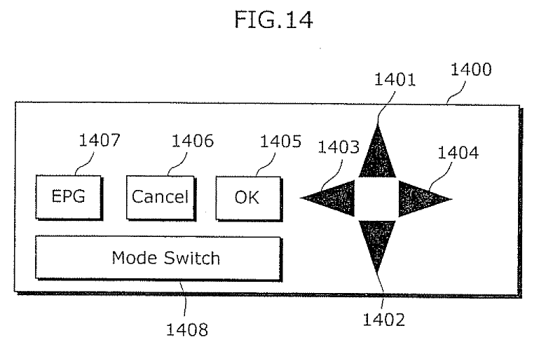

The input unit 1310 is, to be more specific, configured of a front panel or a remote control receiver, and accepts an input from the user. FIG. 14 is one example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switch button 1408. When a user presses a button, an identifier of the pressed button is notified to the CPU 1306.

The adapter 1311 is a device for descrambling the MPEG-2 transport stream sent in the In-band frequency range, and includes one or more descramblers. The MPEG-2 transport stream outputted by the tuner 1301a is inputted into the adapter 1311, and the TS packet that has the PID specified by the CPU 1306 is descrambled. The adapter 1311 outputs the MPEG-2 transport stream, which has been descrambled, to the TS decoder 1302.

Furthermore, the adapter 1311 carries out format conversion of data sent in an OOB frequency range. Information that is sent OOB is modulated in the QPSK modulation format. Regarding outbound transmission, the QPSK demodulator 1301b demodulates the outgoing signal sent from the broadcast station side system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding inbound transmission, the CPU 1306 inputs information to be sent to the broadcast station side system 101 into the adapter 1311. The adapter 1311 converts the information inputted from the CPU 1306 to a format that can be interpreted by the broadcast station side system 101, and inputs this to the QPSK modulator 1301c. The QPSK modulator 1301c QPSK-modulates the information inputted from the adapter 1311, and sends this to the broadcast station side system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313. The AV encoder 1312 can be realized by publicly-known technology.

The multiplexer 1313 is a device which has a function to multiplex, into an MPEG-2 transport stream, video and audio inputted from the AV encoder 1312 as well as private section data filtered and separated by the TS decoder. The multiplexer 1313 can be realized by publicly-known technology.

A process in which the broadcast recording and reproduction apparatus described above records a service contained in a broadcast wave into the secondary storage unit 1307, and a process where the broadcast recording and reproduction apparatus consecutively reads out and reproduces the service from the secondary storage unit 1307, are hereafter described in detail.

First, the process in which the service contained in the broadcast wave is recorded into the secondary storage unit 1307 is described.

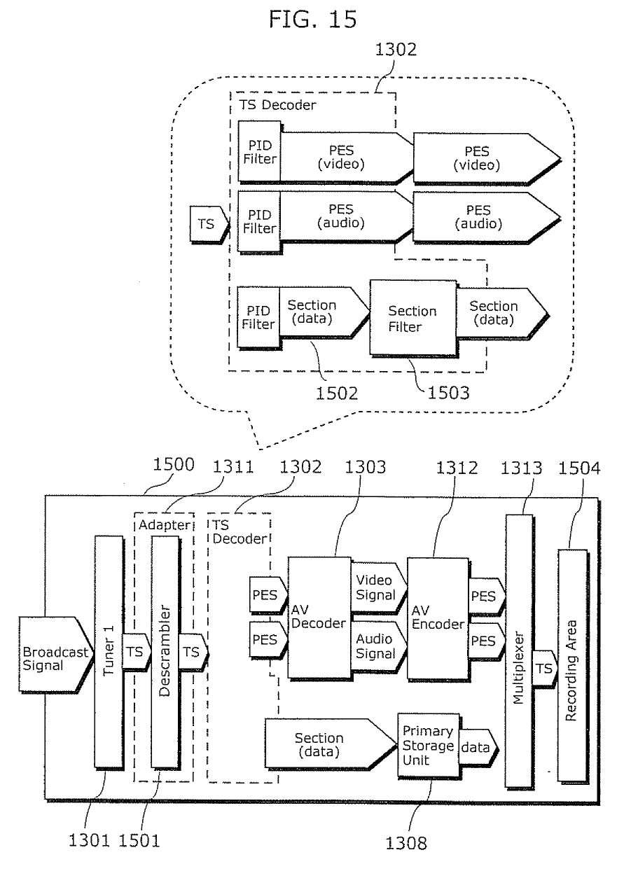

FIG. 15 shows a conceptual rendering which expresses the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 15 that have the same numbers as in FIG. 13 have the same functions and thus description in omitted.

First, the tuner 1301 performs tuning on the broadcast wave in accordance with a tuning instruction provided by the CPU 1306. The tuner 1301 demodulates the broadcast wave and inputs the MPEG-2 transport stream into the adapter 1311.

The descrambler 1501, which is within the adapter 1311, descrambles the MPEG-2 transport stream based on conditional access information for each viewer. The MPEG-2 transport stream, which has been descrambled, is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, a TS packet that has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering which extracts the TS packet with a PID 100, packets 601 and 603 are extracted, then concatenated, and thus a PES packet of a video 1 is reconfigured. Or, when the MPEG-2 transport stream in FIG. 6 is inputted in the case where the CPU 1306 has instructed PID filtering which extracts the TS packet with a PID=200, packets 602 and 605 are extracted, then concatenated, and thus an MPEG-2 section of data 1 is reconfigured.

The section filter 1503 extracts the MPEG-2 section which conforms to a section filter condition specified by the CPU 1306 from among the inputted MPEG-2 sections, and DMA-transfers this MPEG-2 section to the primary storage unit 1308. A PID value can be specified as the section filter condition, and a table_id value can be specified as an auxiliary condition. For example, the CPU 1306 specifies PID filtering which extracts the TS packet with a PID=200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308, which is a buffer.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet and converts the video, and inputs this into the AV encoder 1312. The AV decoder also decodes the audio PES packet and converts the audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder onto the MPEG-2 section inputted from the primary storage unit 1308, and thus generates an MPEG-2 transport stream. The generated MPEG-2 transport stream is recorded into the recording area 1504.

The recording area 1504 is made up of all or a part of the secondary storage unit 1307, or an other recording area, and records the MPEG-2 transport stream that makes up a service.

Next, a process is described in which the service is consecutively read out from the secondary storage unit 1307 and reproduced.

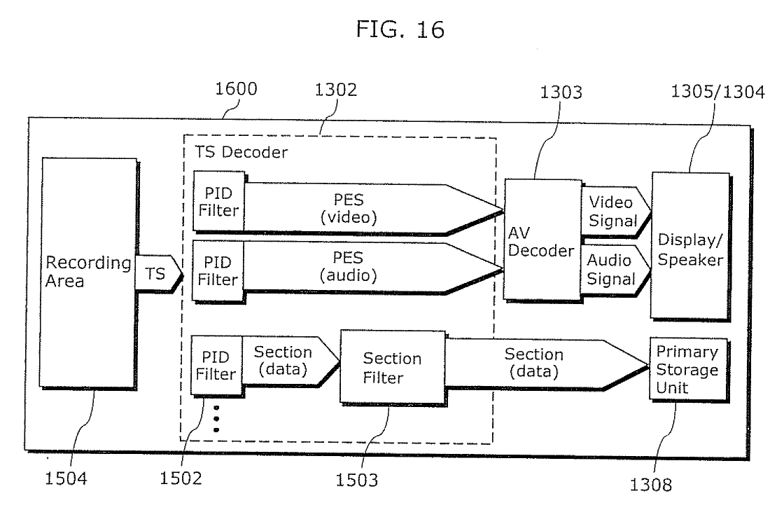

FIG. 16 shows a conceptual rendering which expresses the physical connection sequence, processing details, and input/output data format of each device during reproduction of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same numbers as in FIG. 13 have the same functions and thus description is omitted.

In the order described in FIG. 15, the MPEG-2 transport stream recorded in the recording area 1504 is inputted into the TS decoder 1302.

Then, a video PES and an audio PES that have a PID specified by the CPU 1306 are extracted by the PID filter 1502 within the TS decoder 1302. The extracted PES packet is inputted into the AV decoder 1303. Or, the MPEG-2 section that has a PID and a table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded, and outputted as an audio signal and a video signal. After that, the audio signal and the video signal are inputted into the display 1305 and the speaker 1304, thus reproducing the audio and the video.

The MPEG-2 section inputted into the primary storage unit 1308 is inputted into the CPU 1306 and used by software when appropriate.

Thus far, an example of a hardware configuration regarding the present invention has been described. Hereafter, a chief function of the present invention, which is control of recording and reproduction of the service via a Java program, is described.

Recording of the service in the present invention refers to recording video, audio, a Java program, synchronization information of the Java program, and so on that are contained in the service, into an arbitrary storage medium such as a hard disk, a Blu-ray Disc (BD), a Digital Versatile Disc (DVD), and a Secure Digital (SD) memory card. These storage media are, in the configuration diagram shown in FIG. 13, denoted as the secondary storage unit 1307. Reproduction of the service refers to execution and reproduction of the video, audio, and Java program recorded in the recording medium based on the synchronization information of the Java program. A reproduction result of a recorded service is required to be almost equivalent to a result of directly reproducing the service upon receiving a broadcast wave.

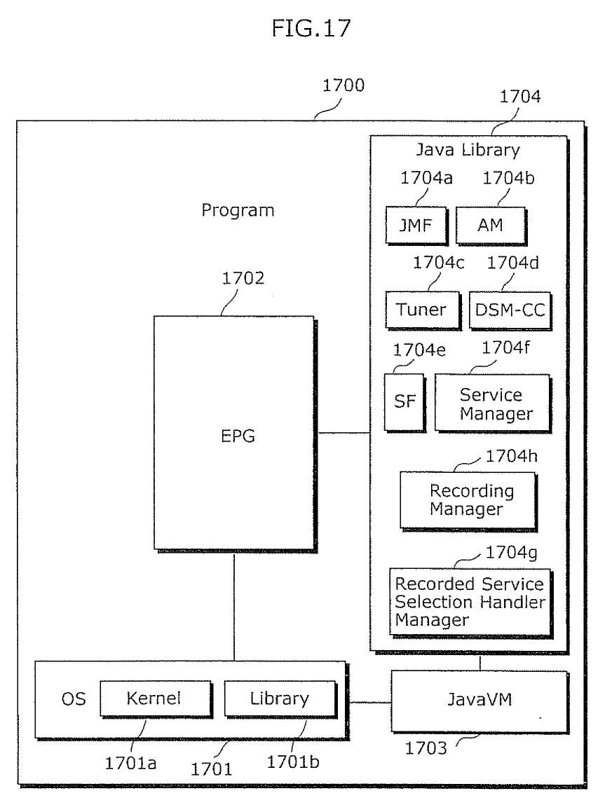

FIG. 17 is a configuration diagram of a program necessary for recording and reproduction of the service, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a for executing other sub-programs such as the EPG 1702 and the Java VM 1703; and a library 1701b which the sub-programs use to control the constituent elements of the terminal apparatus 1300. The kernel 1701a is publicly-known technology and therefore detailed descriptions are omitted.

The library 1701b provides, for example, a tuning function for controlling the tuner. The library 1701b accepts, from another sub-program, tuning information that includes a frequency, and supplies this to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

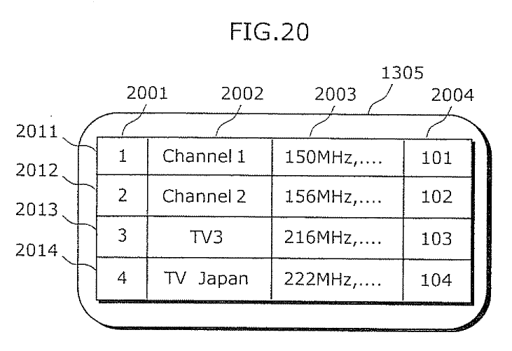

Also, the library 1701b provides channel information for uniquely identifying a channel. An example of the channel information is shown in FIG. 20. The channel information is sent using an OOB or an In-band frequency range, is converted into a chart format by the adapter 1311, and is stored in a temporary memory unit accessible by the library. A column 2001 is a channel identifier, and is equivalent to, for example, a source_ID as defined by SCTE65 Service Information Delivered Out-Of-Band For Digital Cable Television. A column 2002 is a channel name, and is equivalent to a source_name in the same SCTE65 standard. A column 2003 is tuning information, and is information such as a frequency, a transfer rate, a modulation formation, and the like that is given to the tuner 1301. A column 2004 is a program number for specifying the PMT. For example, a row 2011 is a group of service information including a channel identifier of “1”, a channel name of “channel 1”, a frequency of “150 MHz . . . ” in the tuning information, and a program number of “101”.

In addition to this, it is also possible for the library 1701b to set parameters used in control of the hardware constituent elements shown in FIG. 13. Individual functions are described later.

The Java VM 1701 is a Java virtual machine which sequentially analyzes and executes programs written in the Java™ language. Programs written in the Java language are compiled of intermediate code which does not depend on the hardware, called bytecode. The Java virtual machine is an interpreter which executes this bytecode. The Java VM 1703 executes the Java library 1704 that is written in the Java language. Details of the Java language are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are situations where a sub-program not written in the Java language, such as the library 1701b of the OS 1701, is used as necessary. The Java program can use a function provided by the Java library 1740 by calling a Java Application Programming Interface (API) held by the Java library 1704.

A tuner 1704c is a Java library for controlling the In-band receiving tuner 1301a in the broadcast recording and reproduction terminal. When the Java program passes tuning information including a frequency to the tuner 1704c, the tuner 1704 uses that information to invoke a tuning function of the library 1701b, and as a result, it is possible to control an operation of the In-band receiving tuner 1301a of the broadcast recording and reproduction terminal.

An SF 1704e is a Java library for controlling a function of the PID filter 1502 and the section filter 1503 of the broadcast recording and reproduction terminal. When the Java program passes filtering conditions such as a PID, table_id, and the like to the SF 1704e, the SF 1704e uses a function of the library 1701b based on those conditions, sets the filtering conditions in and controls the PID filter 1502 and the section filter 1503, acquires an MPEG-2 section that fulfills desirable filter conditions, and passes the MPEG-2 section to the Java program that set the filter conditions.

A DSM-CC 1704d is a Java library for accessing a file system of a DSM-CC object carousel. The DSM-CC object carousel is included in the MPEG-2 section acquired by the SF 1704e, The DSM-CC is defined by the ISO/IEC 13818-6 standard, and is a mechanism for using the MPEG-2 section to send an arbitrary file.

By using this, it is possible to send a file from a broadcast station to a terminal. Based on a DSM-CC identifier and a file identifier specified by the Java program and so on, the DSM-CC 1704d uses the SF 1704e and acquires the MPEG-2 section, fetches a file based on the ISO/IEC 13818-6 standard, and outputs this file to the primary storage unit 1308, the secondary storage unit 1307, and the like. A detailed method for implementing the DSM-CC is of no relation to the present invention, and therefore details are omitted.

An AM 1704b is an Application Manager that provides a function for managing the execution and termination of the Java programs contained in the service. The AM 1704b extracts a Java program multiplexed into a channel specified by a specified MPEG-2 transport stream, and causes the execution or termination of that extracted Java program in accordance with separately-multiplexed synchronization information. A Java class file of the Java program is multiplexed into the MPEG-2 transport stream in the aforementioned DSM-CC format. In addition, the synchronization information of the Java program is in a format called AIT, and is multiplexed into the MPEG-2 transport stream. AIT is an acronym of Application Information Table, as defined in section 10 of the DVB-MHP specification (ETSITS 101812 DVB-MHP specification V1.0.2), and is an MPEG-2 section with a table_id of “0x74”. In the descriptions of the present embodiment, the AIT used is a modified version of that which is defined by the DVB-MHP specifications.

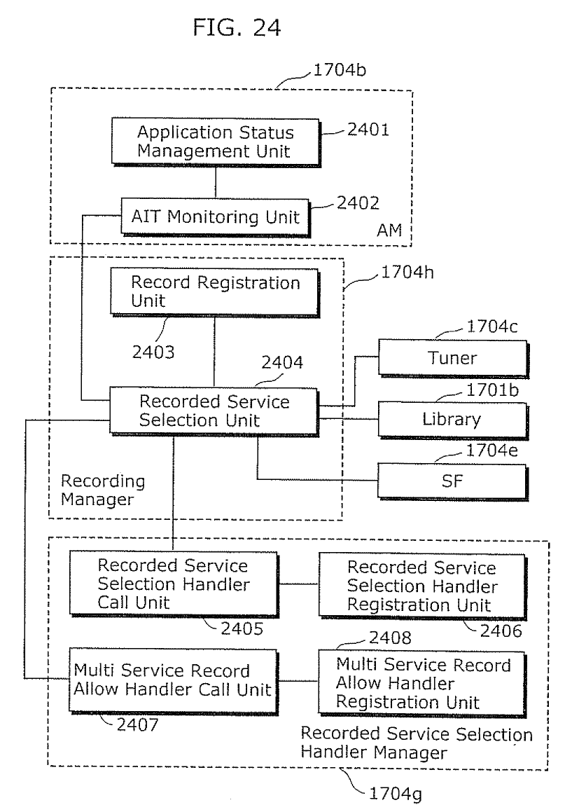

An internal configuration of the AM 1704b is shown in FIG. 24. The AM 1704b is configured of an AIT monitoring unit 2402 and an application status managing unit 2401.

The AIT monitoring unit 2402 monitors an update state of the AIT, with the private section and the channel identifier of the MPEG-2 transport stream that is outputted from the TS decoder at the time of service reproduction and record, as an input. First, the AIT monitoring unit 2402 searches channel information in the library 1701b with a specified channel identifier as a key, and obtains the program number of the corresponding service. Next, using the SF 1704e and the like, a PAT is acquired from the MPEG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PID of an elementary stream that has “data” as a stream identifier and “AIT” as supplemental information. Furthermore, when the PID and table_ID “0x74” of the AIT now obtained as the filtering conditions are given to the SF 1701e, the actual AIT is obtained.

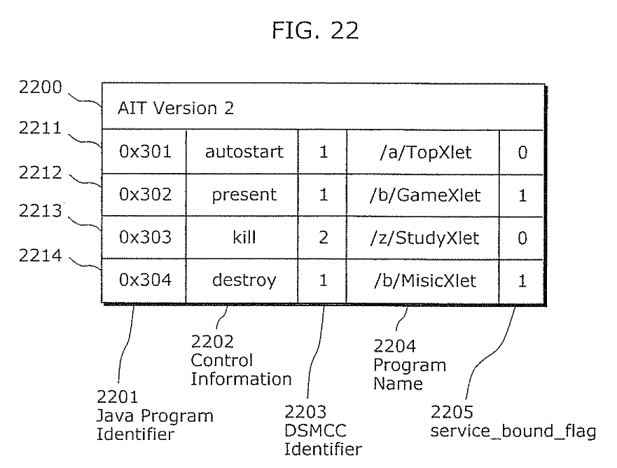

FIG. 22 is a chart that schematically shows an example of information of the AIT. An AIT version number 2200 expresses the version of that AIT. The higher the version of the AIT, the newer the AIT is. AIT of the same AIT version are repeatedly received, but the AIT monitoring unit 2402 ignores and does not acquire AIT with the same AIT version as an AIT that has already been acquired, only acquiring an AIT that is newer than the already-acquired AIT. Note that at this time, there is a possibility that a version upgrade occurs for the PAT and the PMT. Thus, whether or not a version upgrade occurs in the PAT and the PMT is continuously monitored, and in the case where a version upgrade actually occurs in the PAT or the PMT, the actual AIT must be re-acquired through the aforementioned method based on the version-upgraded PAT and PMT. The AIT monitoring unit 2402 outputs the acquired new AIT per AIT to the application status managing unit 2401 and a recording service selection unit 2404. A column 2201 is an identifier of the Java program. According to the MHP standard, this identifier is defined as an Application ID.

A column 2202 is control information of the Java program. In the control information, there is “autostart”, “present”. “kill”, and the like; “autostart” means that the terminal apparatus 1300 executes the Java program automatically in an instant, “present” means not performing automatic execution, and “kill” means stopping the Java program. A column 2203 is a DS-MCC identifier for extracting the PID that includes the Java program in the DS-MCC format. A column 2204 is a program name of the Java program. A column 2205 is a service_bound_flag, where 1 means that the Java program will undoubtedly end when a different service is selected. 0 means that when another service is selected, in the case where the Java program that also corresponds to the AIT of that service is denoted, that Java program continues to be executed without being terminated. However, even in the case of 0, the control information of a Java program in a newly-selected service is given priority. Also in the case of 0, when the newly-selected service has not been recorded, execution of the current Java program is continued as-is.

Note that in such a case, the configuration may be one in which the Java program is terminated. Here, an EPG application in which selective reproduction can be carried out for a specified service only can be given as an example of a Java program in which the service_bound_flag=0. In other words, by including an identical EPG application in which the service_bound_flag=0 in all services to be selectively reproduced, it is possible to continuously execute the EPG application without termination in the case where each service is selectively reproduced from this EPS application. Rows 2211, 2212, 2213, and 2214 are groups of the information of the Java program. The Java program defined by row 2211 is a combination of the Java program identifier “0x3221”, the control information “autostart”, the DSM-CC identifier “1”, and the program name “a/TopXlet”.

The Java program defined in row 2212 is a group including a Java program identifier “0x3222”, the control information “present”, a DSM-CC identifier “1”, and a program name “b/GameXlet”. Here, the three Java programs defined by rows 2211, 2212, and 2214 have the same DSM-CC identifier. This indicates that three Java programs are included in one file system encoded in the DSM-CC format. Here, four types of information are prescribed for the Java program, but in reality, more types of information are defined. Details can be found in the DVB-MHP specifications.

The application status managing unit 2401 analyzes details of the renewed AIT outputted from the AIT monitoring unit 2402, and manages an execution status of the Java program based on those details of the AIT.

First, the application status managing unit 2401 finds a Java program with control information of “autostart” from within the AIT, and extracts the corresponding DSM-CC identifier and Java program name. Referring to FIG. 22, the AM 1704b extracts the Java program from row 2211 and acquires the DSM-CC identifier of “1” and the Java program name of “a/TopXlet”. Next, the application status managing unit 2401 uses the DSM-CC identifier acquired from the AIT to access the DSM-CC 1704d, and can fetch a file of the Java program stored in a DSM-CC file system. The file is stored in the primary storage unit 1308, the secondary storage unit 1307, and so on. Fetching data such as the file system from the TS packet of the MPEG-2 transport stream and saving the data into a storage means such as the primary storage unit 1308 and the secondary storage unit 1307 is hereafter called downloading.

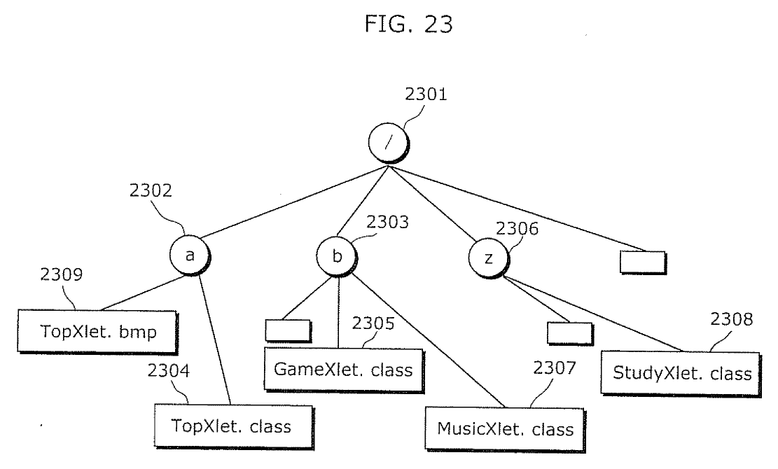

FIG. 23 is an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”.

Next, the application status managing unit 2401 passes the Java program to be executed to the Java VM 1703, from among the file systems downloaded to the primary storage unit 1308. Here, when the name of the Java program to be executed is “A/TopXlet”, the file “a/TopXlet.class”, in which “.class” is added to the end of the Java program name, is the file to be executed. “/” is a directory and file name division, and referring to FIG. 23, the file 2304 is the Java program which should be executed. The file is executed in the Java VM as the Java program.

The application status managing unit 2401 analyzes the AIT each time an AIT with a new AIT version is outputted from the AIT monitoring unit 2402 and changes an execution status of a new Java program.

A JMF 1704a handles control of reproduction of the video and audio contained in the service. Specifically, at the time of reproduction of the service, the JMF 1704a causes a specific video ES and audio ES from the MPEG-2 transport stream outputted from the TS decoder to be inputted into the AV decoder.

An input of the JMF 1704a is a channel identifier of a channel to be reproduced. First, the JMF 1704a searches channel information in the library 1701b with a specified channel identifier as a key, and obtains the program number. Next, using the SF 1704e and the like, the PAT is acquired from the MPEG-2 transport stream. Then, the PID of the PMT that corresponds to the obtained program number is obtained from information of the PMT. Once again, using the SF 1704e, the actual PMT is acquired. The acquired PMT is in a format as shown in FIG. 11, and has written the PIDs of elementary streams that have “video” and “audio” as the stream identifiers. When the JMF 1704a sets those PIDs in the PID filter 1502 of the TS decoder 13212 via the library 1701b, the video ES and the audio ES, onto which those PIDs are multiplexed, are decoded by the AV decoder 1303, as shown in FIG. 15 or FIG. 16. The decoded audio and video are reproduced through the speaker 1304 and the display 1305.

A recorded service selection handler manager 1704g handles registration and execution of a recorded service selection handler for determining whether or not to simultaneously record another service in addition to a service specified at the time of recording. FIG. 24 shows an internal configuration of the recorded service selection handler manager 1704g. The recorded service selection handler manager 1704g includes: a recorded service selection handler registration unit 2406; a recorded service selection handler call unit 2405; a multi service record allow handler registration unit 2408; and a multi service record allow handler call unit 2407.

The recorded service selection handler registration unit 2406 provides a Java API that registers a recorded service selection handler. The Java API is in a registerHandler (Handler h) format, and specifies the recorded service selection handler in h. When this API is called, the specified recorded service selection handler is stored in the primary storage unit 1308.

The recorded service selection handler is a part of the downloaded Java program, and is program code written in the Java language. The recorded service selection handler has a return value of a method Handler.notify that has an array PMT[ ] (AIT ait, PIT pmt, PMT pmt[ ]). The parameter ait is an AIT that includes the service to be recorded; the parameter pmt is the PMT that denotes the service to be recorded; and the parameter pmt[ ] is a PMT group to be simultaneously recorded. These parameters are transmitted from the recorded service selection unit 2404 to the recorded service selection handler call unit 2405. The downloaded Java program refers to information of these parameters, selects the service to record simultaneously with the original service, and returns this as the return value PMT[ ]. Note that a return value of null means that the recorded service selection handler does not particularly specify a desired service to record, and selection of the service to record is left to the recording manager 1704h.

The recorded service selection handler call unit 2405 accepts, from the recorded service selection unit 2404, the AIT that includes the service to be recorded, the PMT that denotes the service to be recorded, and all PMTs that correspond to the service to be simultaneously recorded. Then, the recorded service selection handler call unit 2405 calls, as those pieces of information, a notify method of the recorded service selection handler that is registered in the primary storage unit. After that, the recorded service selection handler call unit 2405 notifies the recorded service selection unit 2404 of the return value PMT[ ] from the recorded service selection handler.

The multi service record allow handler registration unit 2408 provides a Java API that registers a multi service record allow handler. The Java API is in a registerHandler (AllowHandlerh) format, and specifies the multi service record allow handler to h. When this API is called, the specified multi service record allow handler is stored in the primary storage unit 1308.

The multi service record allow handler is a part of the downloaded Java program, and is program code written in the Java language. The multi service record allow handler has, as a return value, a method Handler.allowMultiServiceRec( ) with a Boolean value. When this method is called, the downloaded Java program judges whether or not to allow recording of multiple services simultaneously with the original service, and returns this as the return value. A return value of true means that simultaneous recording of multiple services is allowed. A return of false means that simultaneous recording of multiple services is not allowed, and only the specified service is recorded alone.

The multi service record allow handler call unit 2407 calls the allowMultiServiceRec method of the multi service record allow handler registered in the primary memory upon receiving a multi service record allow judgment request from the recorded service selection unit 2404. After that, the multi service record allow handler call unit 2407 notifies the recorded service selection unit 2404 of the return value from the multi service record allow handler.

The recording manager 1704h records the MPEG-2 transport stream that includes the specified service in the secondary storage unit. FIG. 24 shows an internal configuration of the recording manager 1704h. The recording manager 1704h includes a record registration unit 2403 and the recorded service selection unit 2404.

With the channel identifier, start time, and end time as inputs, the record registration unit 2403 records, in the secondary storage unit 1307, only the space between the start time and the end time of the specified service. The record registration unit 2403 is a Java API for record registration, which has record (int source_id, Time start, Time end). The source_id specifies the channel identifier, start specifies the start time of recording, and end specifies the ending time of recording. In addition, the record registration unit 2403 also accepts a record registration request from non-Java programs. For example, it is possible to specify the channel identifier, start time, and end time from the EPG 1702. When record registration is carried out, the record registration unit 2403 stands by.

After that, upon arriving at a certain time before the record start time, the EPG 1702 supplies the specified channel identifier, record start time, and record end time to the recorded service selection unit 2404, and requests recording of the service. Here, the certain time may be an arbitrary time, but it is desirable for this to be an amount of time in which a preprocessing for recording can be completed by the recorded service selection unit 2404, as is described hereafter. The recorded service selection unit 2404 records the service into the secondary storage unit based on the specified channel identifier, record start time, and record end time.

First, the recorded service selection unit 2404 secures, within the secondary storage unit 1307, a recording area 1504 for recording the MPEG-2 transport stream corresponding to from the specified start time to the specified end time. A media identifier is supplied to the secured recording area. Next, with the channel identifier as a key, the recorded service selection unit 2404 obtains tuning information that corresponds to the channel identifier from channel information held by the library 1701b. After that, when the recorded service selection unit 2404 supplies the tuning information to the Tuner 1704c, the Tuner 1704c commences tuning. Here, the tuning information is information that can be specified, such as a frequency, a modulation method, and the like. In addition, as shown in FIG. 15, an input and output of the hardware constituent elements are set so that the MPEG-2 transport stream is inputted into the TS decoder via the adapter 1311.

Next, using the SF 1704e, the recorded service selection unit 2404 acquires the PAT from the MPEG-2 transport stream obtained through the tuning. After that, the PID of the PMT is acquired from the PAT, and using the SF 1704e, all PMTs within the MPEG-2 transport stream are acquired. In addition, the recorded service selection unit 2404 searches for the program number that corresponds to the specified channel identifier from the library 1701b, and checks the corresponding PMT. Note that in the MPEG standard, the version of the PAT and the PMT may be upgraded. Therefore, the recorded service selection unit 2404 constantly filters and monitors the PATs and the PMTs; when the version of a PAT or a PMT has upgraded, the above process is repeated, and all PMTs in the MPEG-2 transport stream and the PMT of the service to be recorded are obtained.

During the recording process, upon receiving a notification of a new AIT with an upgraded version from the AIT monitoring unit 2402, or detecting a version upgrade of a PAT or a PMT, the recorded service selection unit 2404 notifies the recorded service selection handler call unit 2405 of the newest AIT, the PMT of the service to be recorded as specified by the channel identifier which in turn is specified by the record registration unit 2403, and all PMTs within the MPEG-2 transport stream as the simultaneously recorded service, and requests invocation of the recorded service selection handler. Then, as previously mentioned, the recorded service selection handler call unit 2405 returns the return value of a recording and reproduction handler notify method to the recorded service selection unit 2404.

If a PMT array returns from the recorded service selection handler call unit 2405, a service that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ES that make up a desired channel are recorded into the recording area 1504 that has been secured.

On the other hand, if null returns from the recorded service selection handler call unit 2405, the recorded service selection unit 2404 determines, through the following steps, the service to record simultaneously First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ESs that make up a desired channel are recorded into the recording area 1504 that has been secured.

On the other hand, in the case where there is a Java program in which the service_bound_flag=0, the recorded service selection unit 2404 first requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records all services within the MPEG-2 transport stream. In other words, all the ESs denoted in all the PMTs within the MPEG-2 transport stream, or in other words the audio, video, and all PIDs and table_ids of the section ES that make up the service related to all PMTs, are set in the PID filter 1502 and the section filter 1503 of to the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ES that make up a desired channel are recorded into the recording area 1504 that has been secured.

It is desirable to complete the pre-processing that occurs before recording actually takes place, as described above, prior to the specified record start time. The service may be recorded in the recording area 1504 after the specified start time.

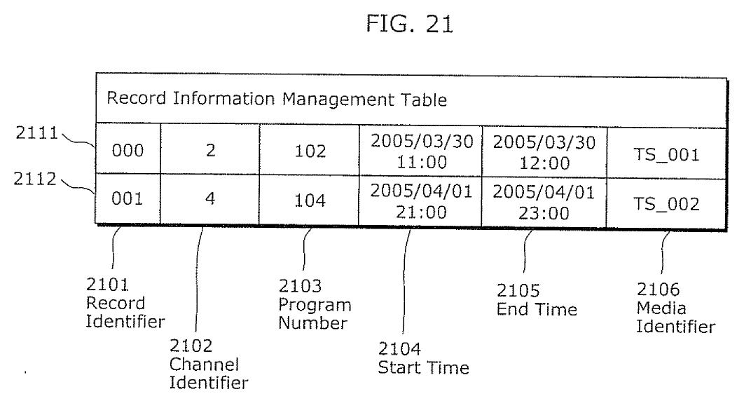

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 21 is created as management information of the MPEG-2 transport stream recorded earlier.

FIG. 21 is an example of the record information management table for managing the record information recorded into the recording area 1504 of the secondary storage unit 1307 and the like. The record information is recorded in chart format. A column 2101 is a record identifier A column 2102 is the channel identifier specified to be recorded. A column 2103 is a corresponding program number. A column 2104 is the record start time for the service, and a column 2105 is the record end time for the service. A column 2106 is a media identifier that identifies the MPEG-2 transport stream that is recorded as the service. Each of rows 2111 to 2112 is a group of each record identifier, channel identifier, program number, beginning time, ending time, and media identifier. For example, row 2111 shows a record identifier of “000”, a channel identifier of “2”, a program number of “102”; a start time of “2005/03/30 11:00”, an end time of “2005/03/30 12:00”, and a media identifier of “TS_{—}001”.

A service manager 1704f manages reproduction of the service within the MPEG2 transport stream that has been recorded into the secondary storage unit 1307, or the service within the MPEG-2 transport stream inputted from the adapter 1311.

Hereafter, a process in the case of managing reproduction of the service contained within the MPEG-2 transport stream recorded in the secondary storage unit 1307 is described. This is equivalent to reproduction of an already-recorded service. In this case, the service manager 1704f has the record identifier as an input. Only the service already recorded in the secondary storage unit 1307 and specified by that record identifier is to be reproduced. First, referring to the record information management table created by the recording manager 1704h, the service manager 1704f obtains the channel identifier and the media identifier of the service to be reproduced, through the specified record identifier. Then, through the library 1701b, the service manager 1704f instructs the secondary storage unit 1307 to output, to the TS decoder 1302, the MPEG-2 transport stream specified by the obtained media identifier. In addition, through the library 1701b, the service manager 1704f sets the output destination of each hardware constituent element to flow through the path shown in FIG. 16. After that, the secondary storage unit 1307 is provided to the JMF 1704a as the location of the MPEG-2 transport stream, and the channel identifier to be reproduced is provided. Then, through the process described above, the JMF 1704a starts reproduction of the audio and video multiplexed into the MPEG-2 transport stream outputted from the secondary storage unit 1307. Furthermore, the channel identifier to be reproduced is provided to the AIT monitoring unit 2402 of the AM 1704b. Then, in accordance with the AIT multiplexed into the MPEG-2 transport stream outputted from the secondary storage unit 1307 via the TS decoder 1302, the AM 1704b commences execution and termination of the Java program multiplexed into the same MPEG-2 transport stream. After that, reproduction of the service is continued until the end of the MPEG-2 transport stream outputted from the secondary storage unit 1307.

On the other hand, the case of managing reproduction of the service within the MPEG-2 transport stream inputted from the adapter 1311 is described hereafter. This is corresponds to reproducing the service directly from the broadcast wave. In this case, the service manager 1704f has the channel identifier of the service to be reproduced as the input. Through the library 1701, the service manager 1704f instructs the MPEG-2 transport stream outputted from adapter 1311 of FIG. 15 to be outputted to the TS decoder 1302. In addition, through the library 1701b, the service manager 1704f sets the output destination of each hardware constituent element to flow through the path shown in FIG. 16. After that, the adapter 1311 is provided to the JMF 1704a as the location of the MPEG-2 transport stream, and the channel identifier to be reproduced is provided. Then, through the process described above, the JMF 1704a starts reproduction of the audio and video multiplexed within the MPEG-2 transport stream outputted from the adapter 1311. Furthermore, the adapter 1311 is provided to the AM 1704b as the location of the MPEG-2 transport stream, and the channel identifier to be reproduced is provided. Then, in accordance with the AIT multiplexed into the MPEG-2 transport stream outputted from the adapter 1311, the AM 1704b commences execution and termination of the Java program multiplexed into the MPEG-2 transport stream outputted from the secondary storage unit 1307. After that, reproduction of the service is continued until the end of the MPEG-2 transport stream outputted from the secondary storage unit 1307.

The EPG 1702 is an Electric Program Guide, and is a function which lets a user choose a TV show to be recorded and reproduced. Normal reproduction through receiving a broadcast wave deviates from the scope of the present invention and thus descriptions are omitted.

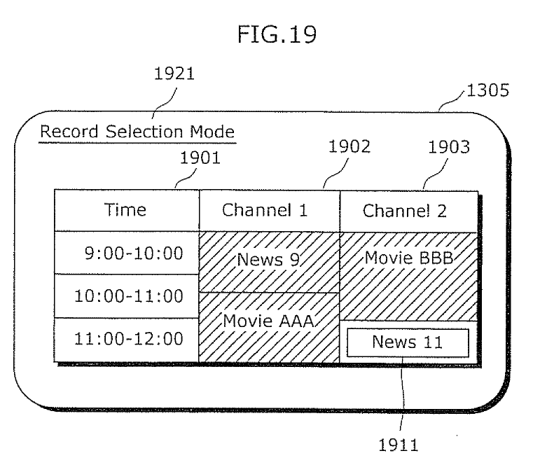

In the case of recording the TV show, the EPG 1702 displays a list of broadcasted TV shows, and lets the user choose a desired TV show. FIG. 19 is an example of a screen display for letting the user select a TV show to be recorded. A time 1901 and channels 1902 and 1903 are displayed in a grid, and it is possible to check the TV shows of each recordable channel at each time. It is possible for the user to move a focus 1911 within the screen by using top, bottom, right, and left cursor buttons 1401 to 1404, which are included in the input unit 1310 of the terminal apparatus 1300. Furthermore, when an OK button 1405 is pushed, the TV show which the focus currently hits is selected to be recorded. The EPG 1702 acquires the channel identifier of the TV show from the library, and when the TV show to be recorded is selected by the user, notifies the channel identifier, start time, and end time of the TV show to the record registration unit 2403 of the recording manager 1704h.

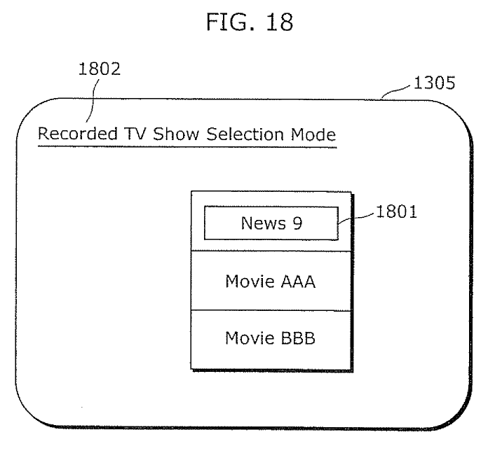

On the other hand, in the case of reproducing an already-recorded TV show, the EPG1702 displays a list of the already-recorded TV shows, and lets the user choose a desired TV show. FIG. 18 is an example of a screen display for causing is selection of an already-recorded TV show. All TV shows stored in the secondary storage unit 1307 at that point in time are listed. It is possible for the user to move a focus 1801 within the screen by using the top and bottom cursor buttons 1401 and 1402, which are included in the input unit 1310 of the terminal apparatus 1300. Furthermore, when the OK button 1405 is pushed, the TV show which the focus currently hits is selected to be reproduced. The EPG 1702 acquires the record identifier of the TV show from recording manager 1704h, and when the TV show to be reproduced is selected by the user, notifies the service manager 1704f of the record identifier of that TV show. Based on that information, the service manager 1704f reads out and reproduces the TV show from the secondary storage unit 1307.

A characteristic operation of the present embodiment configured as described above is shown hereafter.

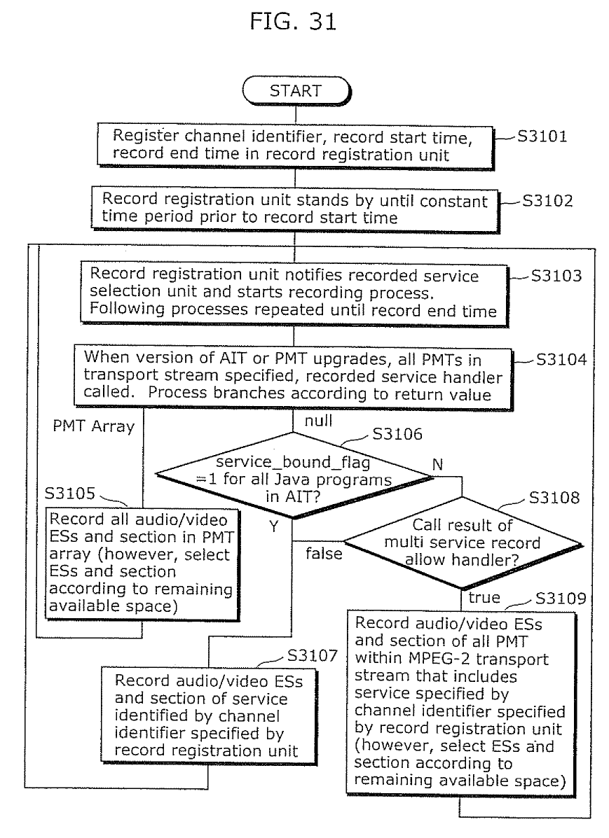

FIG. 31 is a flowchart showing an outline of a process when the service included in the broadcast wave is recorded into the secondary storage unit 1307, in the present embodiment.

In S3101, the Java program or an other program provides the channel identifier, record start time, and record end time to the record registration unit 2403. Then, moving to S3102, the record registration unit 2403 stands by until a constant time period prior to the specified record start time. After that, when the constant time period prior to the specified record start time is reached, the process moves to S3103, and the record registration unit 2403 requests the recorded service selection unit 2404 to commence the recording process. The recorded service selection unit 2404 repeats the following process until the specified record end time is reached.

When a version upgrade of the AIT or PMT, or an update of the PMT caused by a version upgrade of the PAT occurs, the process moves to S3104, and the recorded service selection unit 2404 acquires all PMT within the transport stream that contains the service to be recorded, the service being specified by the channel identifier. The recorded service selection handler call unit 2405 is requested to specify all the PMT and to call a notify method of the recorded service selection handler. The process branches in the following manner according to that return value.

In the case where the return value is a PMT array, the process moves to S3105, and the recorded service selection unit 2404 records, into the secondary storage unit 1307, all the audio/video ESs and sections included in the PMT array, in accordance with the space remaining in the secondary storage unit 1307.

In the case where the return value is null, the process moves to S3106, and a value of the service_bound_flag is examined for all the Java programs of the AIT of the service specified by the specified channel identifier. When the service_bound_flag=1 for all the Java programs, the process moves to S3107, and only the audio/video ESs and section of the service specified by the channel identifier, which in turn is specified by the record registration unit 2403, are recorded into the secondary storage unit 1307.

On the other hand, in S3106, in the case where the service_bound_flag is not 1 for all the Java programs, the process moves to S3108. Here, the multi service record allow handler call unit 2407 is requested to call the AllowMultiServiceRec method of the multi service record allow handler. If that result is false, the process moves to the aforementioned S3107. On the other hand, if that result is true, the process moves to S3109, and the audio/video ESs and sections of all PMT within the MPEG-2 transport stream that includes the service specified by the channel identifier, which in turn is specified by the record registration unit 2403, are recorded into the secondary storage unit 1307, in accordance with the space remaining in the secondary storage unit 1307. When processing after each of the abovementioned branches finishes, the process returns to S3103, and the processing is repeated.

As described above, according to the present embodiment, at the time of recording a service, whether or not to record an other service simultaneously with that service can be determined through a downloaded Java program referring to a number of ESs to be recorded, the available space in a memory unit, and the like. In addition, it is possible to automatically detect whether the Java program included in the service is of a type that can be executed for two or more services, and in the case where the Java program is such an executable type, it is possible to record all recordable services. Through this, even if the Java program actually carries out a service switch during service reproduction, it is possible to continuously execute the Java program without it being abnormally terminated.

### Second Embodiment

Hereafter, an apparatus and a method according to the second embodiment of the present invention are described with reference to the drawings.

A hardware configuration used in the present embodiment is configured as shown in FIG. 13 and FIG. 14. As this has the same configuration and function as in the first embodiment, descriptions are omitted.

In the present embodiment, each hardware constituent element has the following input and output setting.

First, FIG. 15 shows a conceptual rendering which expresses the physical connection sequence, processing details, and input/output data format of each device, in the case where only a specified ES within a service is recorded. Because this is the same configuration as described in the first embodiment, descriptions are hereby omitted.

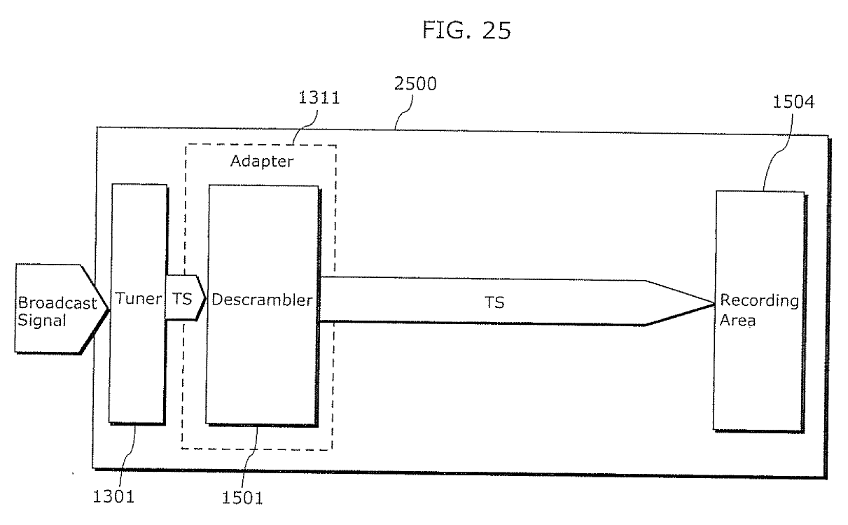

Next, FIG. 25 shows a conceptual rendering which expresses the physical connection sequence, processing details, and input/output data format of each device, in the case where all of an MPEG-2 transport stream that transports a service is recorded. 2500 is terminal apparatus, which includes a tuner 1301, adapter 1311, a descrambler 1501, and a recording area 1504. Constituent elements in FIG. 15 that have the same numbers as in FIG. 13 have the same functions and thus descriptions are omitted. First, the tuner 1301 performs tuning on the broadcast wave in accordance with a tuning instruction provided by the CPU 1306. The tuner 1301 demodulates the broadcast wave and inputs the MPEG-2 transport stream into the adapter 1311. The descrambler 1501, which is within the adapter 1311, descrambles the MPEG-2 transport stream based on conditional access information for each viewer. The MPEG-2 transport stream, which has been descrambled, is recorded into the secondary storage unit.

Finally, FIG. 16 shows a conceptual rendering which expresses the physical connection sequence, processing details, and input/output data format of each device during reproduction of the service from a secondary storage unit. Because this is the same configuration as described in the first embodiment, descriptions are hereby omitted.

Thus far, an example of a hardware configuration regarding the present invention has been described. Hereafter, a chief function of the present invention, which is control of recording and reproduction of the service via a Java program, is described.

A software configuration used in the present embodiment is configured as shown in FIG. 17 and FIG. 24. In addition, FIG. 18 to FIG. 23, used in the first embodiment, are used again here to describe configurations of each type of data and a screen configuration.

Regarding FIG. 17 and FIG. 24, constituent elements aside from the recorded service selection unit 2404 and the recorded service selection handler call unit 2405 are identical to those described in first embodiment, and therefore descriptions are omitted.

The recorded service selection handler call unit 2405 of the present embodiment is a partly modified version of the recorded service selection handler call unit 2405 of the first embodiment, and an output value differs from that of the first embodiment. In addition, in accordance with this, a notify method of the recorded service selection handler is of a different format. A Handler.notify (AITait, PMTpmt, PMTpmt[ ]) method of the present embodiment takes on an integer int value as a return value. A return value of 0 indicates that the recorded service selection handler does not intend to determine selection of the service to record. A return value of 1 indicates that only a specified service to be recorded is recorded. A return value of 2 indicates that the entire MPEG-2 transport stream that transports the service to be recorded is recorded. The recorded service selection handler call unit 2405 returns the return value of this notify method to the recorded service selection unit 2404.

The recorded service selection unit 2404 of the present embodiment is a partly modified version of the recorded service selection unit 2404 of the first embodiment, and the process following the notify method invocation by the recorded service selection handler call unit 2405 differs from the first embodiment.

If a return value of 1 returns from the recorded service selection handler call unit 2405, only the service to be recorded specified by the channel identifier is recorded. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ES that make up a desired channel are recorded into the recording area 1504 that has been secured.

If a return value of 2 returns from the recorded service selection handier call unit 2405, the entire MPEG-2 transport stream that transports the service to be recorded is recorded. In this case, as shown in FIG. 25, the recorded service selection unit 2404 sets an output destination of each hardware constituent element via the library 1701b, in accordance with input and output operations occurring when the entire MPEG-2 transport stream that transports the service is recorded. Then, in accordance with the flow described in FIG. 25, the entire MPEG-2 transport stream that transports the service to be recorded is recorded into the secured recording area 1504.

On the other hand, if a return value of 0 returns from the recorded service selection handler call unit 2405, the recorded service selection unit 2404 determines, through the following steps, the service to record simultaneously.

First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service are set in the PID filter 1502 and the section filter 1503 of the TS decoder. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ESs that make up a desired channel are recorded into the recording area 1504 that has been secured.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records the entire MPEG-2 transport stream that transports the service to be recorded. In this case, as shown in FIG. 25, the recorded service selection unit 2404 sets an output destination of each hardware constituent element via the library 1701b, in accordance with input/output operations occurring when the entire MPEG-2 transport stream that transports the service is recorded. Then, in accordance with the flow described in FIG. 25, the entire MPEG-2 transport stream that transports the service to be recorded is recorded into the secured recording area 1504.

It is desirable to complete the preprocessing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 21 is created as management information of the MPEG-2 transport stream recorded earlier.

The processes aside from those mentioned above are the same as in the first embodiment.

A characteristic operation of the present embodiment configured as described above is shown hereafter.

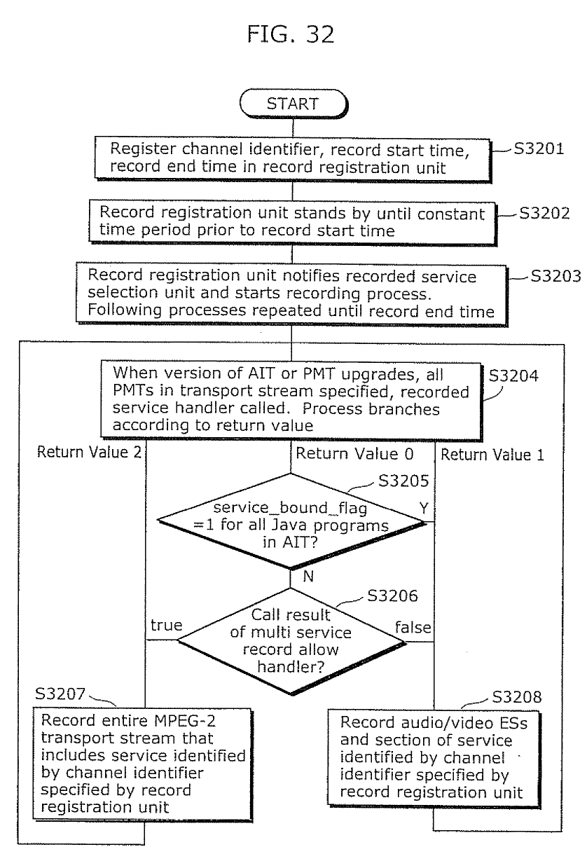

FIG. 32 is a flowchart showing an outline of a process when the service included in the broadcast wave is recorded into the secondary storage unit 1307, in the present embodiment.

In S3201, the lava program or an other program provides the channel identifier, record start time, and record end time to the record registration unit 2403. Then, moving to S3202, the record registration unit 2403 stands by until a constant time period prior to the specified record start time. After that, when the constant time period prior to the specified record start time is reached, the process moves to S3203, and the record registration unit 2403 requests the recorded service selection unit 2404 to commence the recording process. The recorded service selection unit 2404 repeats the following process until the specified record end time is reached.

When a version upgrade of the AIT or PMT, or an update of the PMT caused by a version upgrade of the PAT occurs, the process moves to S3204, and the recorded service selection unit 2404 acquires all PMT within the transport stream that contains the service to be recorded, the service being specified by the channel identifier. The recorded service selection handler call unit 2405 is requested to specify all the PMT and to call a notify method of the recorded service selection handler. The process branches in the following manner according to that return value.

In the case where the return value is 2, the process moves to S3207, and all of the MPEG-2 transport stream that includes the service specified by the channel identifier, which in turn is specified by the record registration unit 2403, is recorded into the secondary storage unit 1307.

In the case where the return value is 1, the process moves to S3208, and the video/audio ESs and section of only the service specified by the channel identifier, which in turn is specified by the record registration unit 2403, is recorded into the secondary storage unit 1307.

In the case where the return value is 0, the process moves to S3205, and a value of the service_bound_flag is examined for all the Java programs of the AIT of the service specified by the specified channel identifier. In the case where the service_bound_flag=1 for all the Java programs, the process moves to S3208, described earlier On the other hand, in the case where the service_bound_flag is not 1 for all the Java programs, the process moves to S3206, and the multi service record allow handler call unit 2407 is requested to call the AllowMultiServiceRec method of the multi service record allow handler. If that result is false, the process moves to the aforementioned S3208. However, if that result is true, the process moves to the aforementioned S3207.

When processing after each of the abovementioned branches finishes, the process returns to S3203, and the processing is repeated.

According to the present embodiment, when recording a service, it is possible to determine whether to record only that service or to record the entire MPEG-2 transport stream which transports that service through the downloaded Java program referring to the remaining available space in a storage unit. In addition, it is possible to automatically detect whether the Java program included in the service is of a type that can be executed for two or more services, and in the case where the Java program is such an executable type, it is possible to record the entire MPEG-2 transport stream that transports the service. Through this, even if the Java program actually carried out a service switch during service reproduction, it is possible to continuously execute the Java program without it being abnormally terminated.

### Third Embodiment

Hereafter, an apparatus and a method according to the third embodiment of the present invention are described with reference to the drawings.

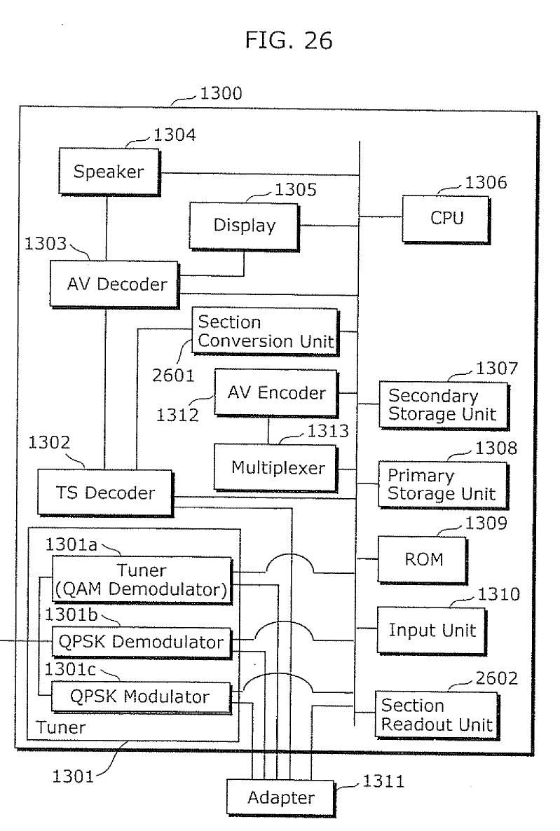

FIG. 26 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; a section conversion unit 2601; and a section readout unit 2602. Aside from the multiplexer 1313, the section conversion unit 2601, and the section readout unit 2602, elements that have the same names and numbers as those described in FIG. 13 in the first embodiment are identical to those described in the first embodiment, and therefore descriptions are omitted.

The multiplexer 1313 differs from that of the first embodiment in that it does not multiplex an AIT section and a DSM-CC section. Aside from that, the multiplexer 1313 is the same.

The section conversion unit 2401 converts the section that is not multiplexed by the multiplexer into a file, and records the file into a recording area 1504 of the secondary storage unit 1307. After passing through the primary storage unit 1308, the AIT section and the DSM-CC section that are filtered by the TS decoder 1302 pass through the section conversion unit 2401 and are recorded into the recording area 1504 without going through the multiplexer Here, a recording method when recording the section into the recording area 1504 differs depending on a format of the section.

In the case of a file system recorded within an MPEG-2 transport stream in a DSM-CC file system format, the section conversion unit 2401 converts this file system into a file system format unique to the recording area 1504, which is in turn unique to a terminal, and records the file system into the recording area 1504.

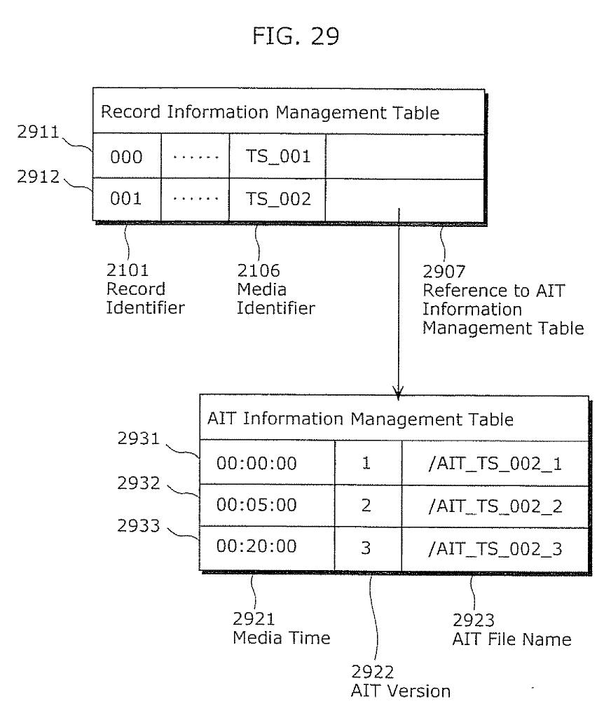

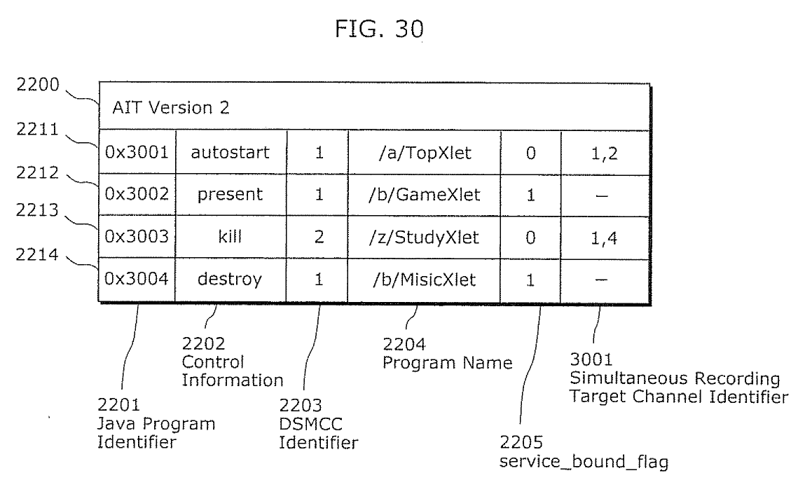

In addition, in the case of an AIT, the section conversion unit 2401 converts the AIT to an expanded record information management table format, as in FIG. 29, and records the AIT into the recording area 1504. The record information management table shown in FIG. 26 is an expanded version of the record information management table shown in FIG. 21; items identified with the same numbers in both tables have the same meaning as those in the record information management table shown in FIG. 21. The section conversion unit 2401 creates an AIT information management table part, and merges this with the record information management table when the recorded service selection unit 2404 creates the record information management table.

Each of rows 2911 and 2912 shows record information for one service. Each of the rows 2911, 2912 have a record identifier 2101, a channel identifier 2102, a program number 2103, a service record start time 2104, a service record end time 2105, a media identifier 2106, and a reference 2907 to an AIT information management table. The AIT information management table has a media time 2921 and an AIT version 2922 corresponding thereto.

The media time 2921 is the time at the time of reproduction of the corresponding MPEG-2 transport stream, and is a time stamp showing a position in the corresponding MPEG-2 transport stream. An AIT version number 2922 corresponds to an AIT version 2200 in FIG. 22. For example, record information of the service that has a record identifier 2101 of “001” has a media identifier 2106 of “TS_{—}002”, and at the media time 2921 of “00:00:00” in the referred AIT information management table, the corresponding AIT version 2922 is “1”. In the same manner, the AIT version 2922 corresponding to the media time 2921 of “00:05:00” is “2”, and the AIT version 2922 corresponding to the media time 2921 of “100:20:00” is “3”.

For example, at the time of reproduction of the service that has a channel identifier 2901 of “001”, referring to the record information management table, the MPEG-2 transport stream that is multiplexed with the video and audio specified by the media identifier 2902 of “TS_{—}002” is reproduced; in addition, referring to the AIT information management table, when the media time 2921 reaches “00:00:00”, control which causes the lava program to start up or terminate is performed in accordance with the AIT with an AIT version 2922 of “1”. In a similar manner, the control which causes the Java program to start up or terminate is performed in accordance with the AIT with an AIT version 2922 of “2” when the media time 2921 reaches “00:05:00”, and in accordance with the AIT with an AIT version number 2922 of “3” when the media time 2921 reaches “00:20:00”. The actual AIT is converted, as a binary file in private section format, into the file system format unique to the recording area 1504, which is in turn unique to a terminal, and is recorded into the recording area 1504. The recorded file is given a unique file name by which it can be uniquely identified, and which is recorded in the record information administration table as an AIT file name 2923.

In an actual broadcast wave, AITs with the same AIT version are repeatedly transmitted any number of times, but in the present embodiment, by detecting a change in the received AIT version, only the first AIT that is updated at that point in time is recorded into the recording area 1504.

The section readout unit 2602 searches for the media time that corresponds to the present reproduction time of the MPEG-2 transport stream read out from the recording area, and reads out, from a file, the AIT and DSM-CC file system corresponding to that media time, and passes these to a software AIT monitoring unit 2402. In other words, the AIT monitoring unit 2402 does not refer to a filtering result of the TS decoder as in the first embodiment, but rather obtains an AIT binary file and a DSM-CC file system from the section readout unit 2602.

FIG. 14 is configuration example of the input unit 1310 in the present embodiment. Because this is the same as described in the first embodiment, descriptions are omitted.

A process in which the broadcast recording and reproduction apparatus described above records a service contained in a broadcast wave into the secondary storage unit 1307, and a process where the broadcast recording and reproduction apparatus consecutively reads out and reproduces the service from the secondary storage unit 1307, are described hereafter in detail.

First, the process in which the service contained in the broadcast wave is recorded into the secondary storage unit 1307 is described.

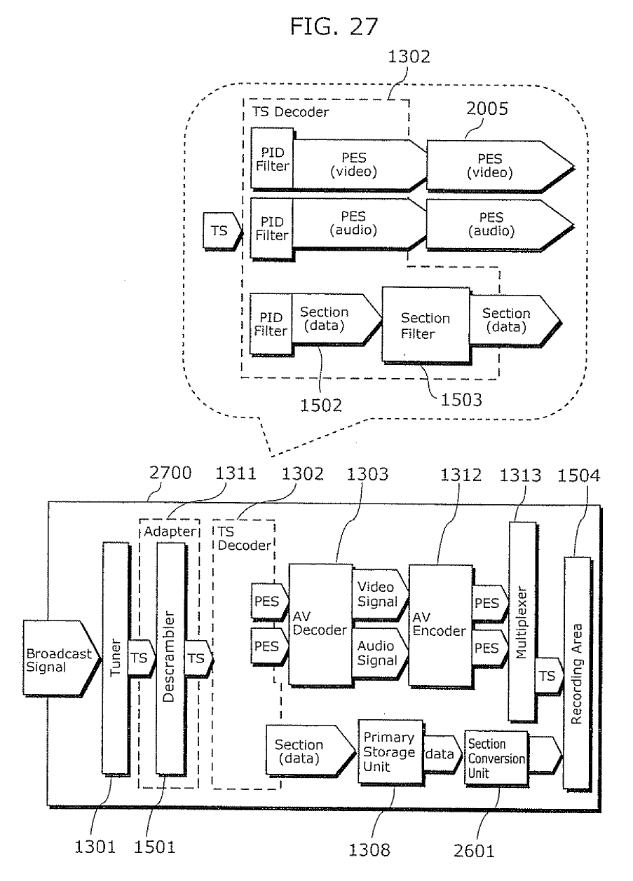

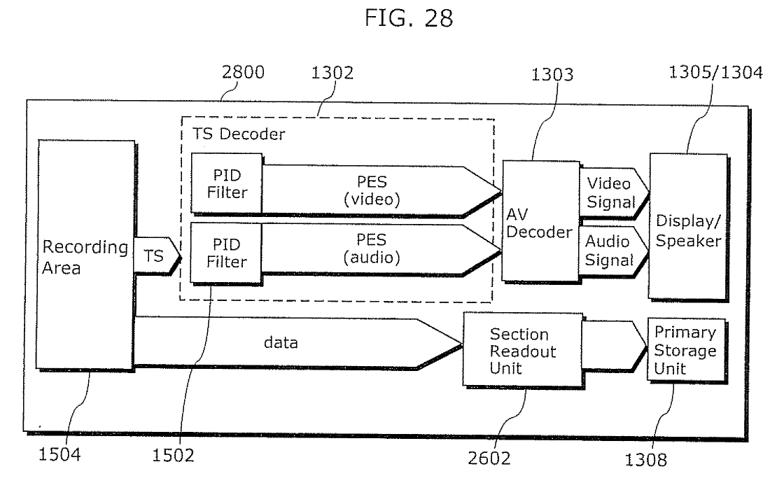

FIG. 27 shows a conceptual rendering which expresses the physical connection sequence, processing details, and input/output data format of each device during recording of the service. Constituent elements in the figure that have identical numbers to the constituent elements shown in FIG. 15 have already been described in the first embodiment, and therefore descriptions are omitted. As opposed to FIG. 15, with the hardware configuration shown in FIG. 27, after passing through the primary storage unit 1308, the AIT section and the DSM-CC section that are filtered by the TS decoder 1302 pass through the section conversion unit 2601 and are recorded to the recording area 1504 without going through the multiplexer.

Next, description is given regarding a process in which the recorded MPEG-2 transport stream is sequentially read out from the secondary storage unit 1307 and the service is reproduced.

FIG. 28 shows a conceptual rendering which expresses the physical connection sequence, processing details, and input/output data format of each device during recording of the service. Constituent elements in the figure that have identical numbers to the constituent elements shown in FIG. 16 have already been described in the first embodiment, and therefore descriptions are omitted.

The hardware configuration of FIG. 28 differs from that in FIG. 16 in that the section recorded into the recording area 1504 is read into the primary storage through the section readout unit 2901 by primary storage without going through the TS decoder.

Thus far, an example of a hardware configuration regarding the present invention has been described. Hereafter, a chief function of the present invention, which is control of recording of the service and control of trick play via a Java program, is described.

A software configuration used in the present embodiment is configured as shown in FIG. 17 and FIG. 24. In addition, FIG. 18 to FIG. 23, used in the first embodiment, are used again here to describe configurations of each type of data and a screen configuration.

Regarding FIG. 17 and FIG. 24, constituent elements aside from the application status management unit 2401, the AIT management unit 2402, and the recorded service selection unit 2404 are identical to those described in first embodiment, and therefore descriptions are omitted.

In the present embodiment, the AIT monitoring unit 2402 is a partly modified version of the AIT monitoring unit 2402 in the first embodiment, and differs in that instead of filtering and acquiring the AIT multiplexed into the MPEG-2 transport stream read out from the secondary storage unit 1307, the AIT monitoring unit 2402 reads out an AIT file that has been separately recorded into the secondary storage unit 1307. The AIT monitoring unit 2402 verifies the AIT corresponding to the present media time in accordance with progress of service reproduction or recording with the media time 2921 in the AIT information management table, acquires the AIT file name that corresponds with the current media time, and reads out the actual AIT file. The media time progresses, and when a time is reached in which a different AIT should be referred to, a new AIT is fetched. In other words, this is equivalent to a version upgrade in the AIT. Therefore, a valid time of the AIT of a current version runs from a valid start media time of that AIT until the valid start media time of an other AIT.

Processes aside from this are the same as those of the AIT monitoring unit 3231 of the first embodiment.

The application status management unit 2401 of the present embodiment is a partly modified version of the application status management unit 2401 of first embodiment, and reads out a lava class file recorded in an original file system format from the secondary storage unit 1307, instead of reading out a Java program read from the DSM-CC section multiplexed with the MPEG-2 transport stream. Processes aside from this are the same as those of the application status management unit in the first embodiment.

The recorded service selection unit 2404 of the present embodiment is a partly modified version of the recorded service selection unit 2404 of the first embodiment, and the process that follows the return value of the notify method of the recording and reproduction handler returning from the recorded service selection handler call unit 2405 differs from the first embodiment.

If a PMT array returns from the recorded service selection is handler call unit 2405, a service group that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space.

Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the recording area 1504 that has been secured.

On the other hand, if null returns from the recorded service selection handler call unit 2405, the recorded service selection unit 2404 determines, through the following steps, the service to record simultaneously.

First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier In other words, all the ESs denoted in the PMT of the service to be recorded, or in other words the audio, video, and all PIDs and table_ids of the section ES that make up the service, are set in the PID filter 1502 and the section filter 1503 of the TS decoder After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the secured recording area 1504.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records all services within the MPEG-2 transport stream. In other words, all the ESs denoted in all the PMTs within the MPEG-2 transport stream, or in other words the audio, video, and all PIDs and table_ids of the section ES that make up the service related to all PMTs, are set in the PID filter 1502 and the section filter 1503 of the TS decoder.

However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ES that make up a desired channel are recorded into the recording area 1504 that has been secured.

It is desirable to complete the pre-processing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 29 is created as management information of the MPEG-2 transport stream recorded earlier. Note that the AIT information management table part is merged with the table created by the section conversion unit 2401. Processes aside from this are the same as with the application status management unit in the first embodiment.

A characteristic operation of the present embodiment configured as described above is shown hereafter.

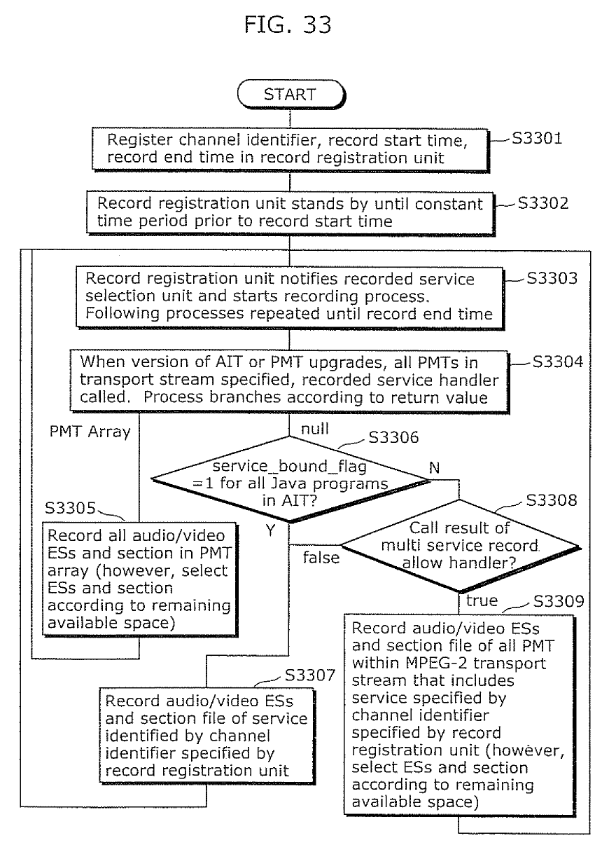

FIG. 33 is a flowchart showing an outline of a process when the service included in the broadcast wave is recorded into the secondary storage unit 1307, in the present embodiment.

In S3301, the Java program or an other program provides the channel identifier record start time, and record end time into the record registration unit 2403. Then, moving to S3302, the record registration unit 2403 stands by until a constant time period prior to the specified record start time. After that, when the constant time period prior to the specified record start time is reached, the process moves to S3303, and the record registration unit 2403 requests the recorded service selection unit 2404 to commence the recording process. The recorded service selection unit 2404 repeats the following process until the specified record end time is reached.

When a version upgrade of the AIT or PMT, or an update of the PMT caused by a version upgrade of the PAT occurs, the process moves to S3304, and the recorded service selection unit 2404 acquires all PMT within the transport stream that contains the service to be recorded, the service being specified by the channel identifier. The recorded service selection handler call unit 2405 is requested to specify all the PMT and to call a notify method of the recorded service selection handler. The process branches in the following manner according to that return value.

In the case where the return value is a PMT array, the process moves to S3305, and the recorded service selection unit 2404 records, into the secondary storage unit 1307, all the audio/video ESs and section files included in the PMT array, in accordance with the space remaining in the secondary storage unit 1307.

In the case where the return value is null, the process moves to S3306, and a value of the service_bound_flag is examined for all is the Java programs of the AIT of the service specified by the specified channel identifier. In the case where the service_bound_flag=1 for all the Java programs, the process moves to S3307, and the video/audio ESs and section file of only the service specified by the channel identifier, which in turn is specified by the record registration unit 2403, is recorded into the secondary storage unit 1307.

On the other hand, in S3306, in the case where the service_bound_flag is not 1 for all the Java programs, the process moves to S3308. Here, the multi service record allow handler call unit 2407 is asked to call the AllowMultiServiceRec method of the multi service record allow handler. If that result is false, the process moves to the aforementioned S3307. On the other hand, if that result is true, the process moves to S3309, and the audio/video ESs and sections of all PMT within the MPEG-2 transport stream that includes the service specified by the channel identifier, which in turn is specified by the record registration unit 2403, are recorded into the secondary storage unit 1307, in accordance with the space remaining in the secondary storage unit 1307. When processing after each of the abovementioned branches finishes, the process returns to S3303, and the processing is repeated.

As described above, according to the present embodiment, at the time of recording a service, whether or not to record an other service simultaneously with that service can be determined through a downloaded Java program referring to the available space in a memory unit, and the like. In addition, it is possible to automatically detect whether the Java program included in the service is of a type that can be executed across two or more services, and in the case where the Java program is such an executable type, it is possible to record all recordable services. Through this, even if the Java program actually carries out a service switch during service reproduction, it is possible to continuously execute the Java program without it being abnormally terminated. Furthermore, because the private section which repeatedly sends the same data, such as the AIT and the DSM-CC, is converted into file format, and is only recorded when there is an update, it is possible to conserve space in the storage unit.

### Fourth Embodiment

Hereafter, an apparatus and a method according to the fourth embodiment of the present invention are described with reference to the drawings.

A hardware configuration used in the present embodiment is configured as shown in FIG. 13 and FIG. 14. As this has the same configuration and function as in the first embodiment, descriptions are omitted

In the present embodiment, each hardware constituent element has the following input and output setting.

First, FIG. 15 shows a conceptual rendering which expresses the physical connection sequence, processing details, and input/output data format of each device, in the case of recording only a specified ES within a service. Because this is the same configuration as described in the first embodiment, descriptions are hereby omitted.

Next, FIG. 16 shows a conceptual rendering which expresses the physical connection sequence, processing details, and input/output data format of each device during reproduction of the service from a secondary storage unit. Because this is the same configuration as described in the first embodiment, descriptions are hereby omitted.

Thus far, an example of a hardware configuration regarding the present invention has been described. Hereafter, a chief function of the present invention, which is control of recording and reproduction of the service via a lava program, is described.

In addition, FIG. 18 to FIG. 21 and FIG. 23r which are used in the first embodiment, are used again here to describe configurations of each type of data and a screen configuration used in the present embodiment. In the present embodiment, AIT of a format shown in FIG. 30, instead of that shown in FIG. 22, is used. Regarding the AIT shown in FIG. 30, elements with names or numbers identical to those shown in FIG. 22 are identical to those described in the first embodiment, and therefore descriptions are omitted. In FIG. 30, a recording target channel identifier 3001 has been newly added. FIG. 30 lists the channel identifiers of the services to be simultaneously recorded, so that each lava program is executed normally. For example, this means that for a lava program in column 2211 to operate normally, it is necessary to simultaneously record the services that have channel identifiers of 1 and 2.

A software configuration used in the present embodiment is configured as shown in FIG. 17 and FIG. 24. Regarding FIG. 17 and FIG. 24, constituent elements aside from the recorded service selection unit 2404 are identical to those described in first embodiment, and therefore descriptions are omitted.

The recorded service selection unit 2404 of the present embodiment is a partly modified version of the recorded service selection unit 2404 of the first embodiment, and the process following i) receiving a notification from an AIT monitoring unit regarding a new AIT, the version of which has upgraded, during recording operations or ii) detecting an upgrade of a version in the PAT and the PMT differs from the first embodiment. At this time, the recorded service selection unit 2404 first examines the simultaneous recording target channel identifier 3001, in the new AIT, the version of which has upgraded, received from the AIT monitoring unit 2402. With the exception of redundancies, the simultaneous recording target channel identifiers 3001 written in all lava programs denoted in the AIT are listed.

In the example of the AIT shown in FIG. 30, with the exception of redundancies, the simultaneous recording target channel identifiers are 1, 2, and 4. After that, the recorded service selection unit 2404 notifies the recorded service selection handler call unit 2405 of the newest AIT, the PMT corresponding to the simultaneous recording target channel identifier with the exception of redundancies, and the PMT of the service to be recorded, and requests a call of the recorded service selection handler. Then, as previously mentioned, the recorded service selection handler call unit 2405 returns the return value of a recording and reproduction handler notify method to the recorded service selection unit 2404.

If a PMT array returns from the recorded service selection handler call unit 2405, a service group that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space.

Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow explained in FIG. 15, all ESs that make up a desired channel are recorded into the recording area 1504 that has been secured.

On the other hand, if null returns from the recorded service selection handler call unit 2405, the recorded service selection unit 2404 determines, through the following steps, the service to record simultaneously.

First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ESs that make up a desired channel are recorded into the recording area 1504 that has been secured.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records all the services specified by the simultaneous recording target channel identifier, with the exception of redundancies. In other words, all the ESs denoted in the PMT group that corresponds to the simultaneous recording target channel identifier, or in other words the audio, video, and all PIDs and table_ids of the section ES that make up the service related to the PMTs, are set in the PID filter 1502 and the section filter 1503 of the TS decoder.

However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ESs that make up a desired channel are recorded into the recording area 1504 that has been secured.

It is desirable to complete the pre-processing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 21 is created as management information of the MPEG-2 transport stream recorded earlier.

The processes aside from those mentioned above are the same as in the first embodiment.

A characteristic operation of the present embodiment configured as described above is shown hereafter.

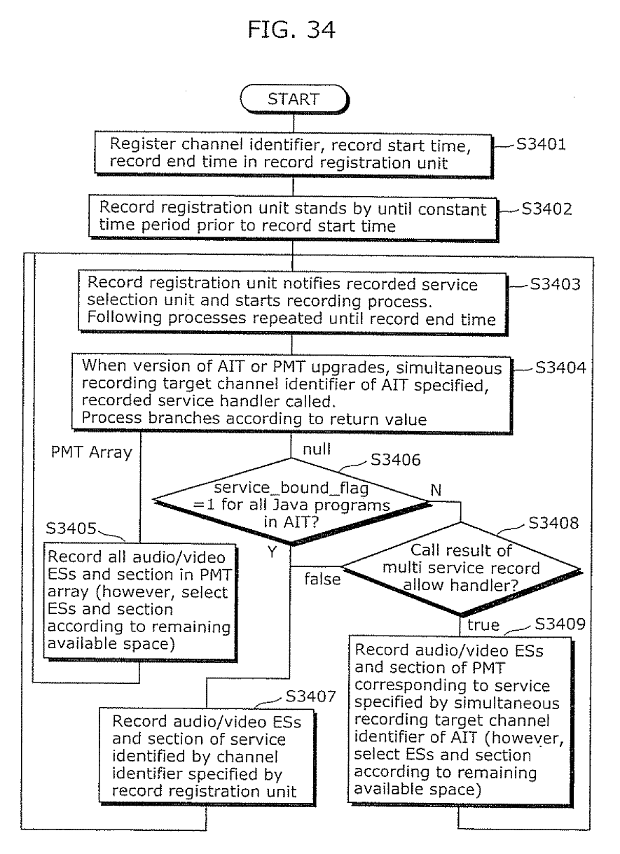

FIG. 34 is a flowchart showing an outline of a process when the service included in the broadcast wave is recorded into the secondary storage unit 1307, in the present embodiment.

In S3401, the Java program or an other program provides the channel identifier, record start time, and record end time to the record registration unit 2403. Then, moving to S34021 the record registration unit 2403 stands by until a constant time period prior to the specified record start time. After that, when the constant time period prior to the specified record start time is reached, the process moves to S3403, and the record registration unit 2403 requests the recorded service selection unit 2404 to commence the recording process. The recorded service selection unit 2404 repeats the following process until the specified record end time is reached.

When a version upgrade of the AIT or PMT, or an update of the PMT caused by a version upgrade of the PAT occurs, the process moves to S3404, and the recorded service selection unit 2404 examines the simultaneous recording target channel identifier if the AIT that includes the service to be recorded specified by the channel identifier, and determines the service to be simultaneously recorded. The recorded service selection unit 2404 specifies the service to be simultaneously recorded, and requests the recorded service selection handler call unit 2405 to call the notify method of the recorded service selection handier The process branches in the following manner according to that return value.

In the case where the return value is a PMT array, the process moves to S3405, and the recorded service selection unit 2404 records, into the secondary storage unit 1307, all the audio/video ESs and sections included in the PMT array, in accordance with the space remaining in the secondary storage unit 1307.

In the case where the return value is null, the process moves to S3406, and a value of the service_bound_flag is examined for all so the Java programs of the AIT of the service specified by the specified channel identifier.

In the case where the service_bound_flag=1 for all the Java programs, the process moves to S3407, and the video/audio ESs and section of only the service specified by the channel identifier, which in turn is specified by the record registration unit 2403, is recorded into the secondary storage unit 1307.

On the other hand, in S3406, in the case where the service_bound_flag is not 1 for all the Java programs, the process moves to S3408. Here, multi service record allow handler call unit 2407 is requested to call the AllowMultiServiceRec method of the multi service record allow handler. If that result is false, the process moves to the aforementioned 53407. On the other hand, if the result is true, the process moves to S3409, and the video/audio ESs and section of all PMTs that correspond to the service to be simultaneous recorded are recorded into the secondary storage unit 1307, in accordance with the space remaining in the secondary storage unit 1307.

When processing after each of the abovementioned branches finishes, the process returns to S3403, and the processing is repeated.

According to the present embodiment, in addition to the effects of the first embodiment, only the service necessary for normal execution of the Java program is selectively recorded, thus making possible normal execution of the Java program without wasteful consumption of space in the storage unit.

### Fifth Embodiment

Hereafter, an apparatus and a method according to the fifth embodiment of the present invention are described with reference to the drawings.

A hardware configuration used in the present embodiment is configured as shown in FIG. 13 and FIG. 14. As this has the same configuration and function as in the first embodiment, descriptions are omitted.

In the present embodiment, each hardware constituent element has the following input and output setting.

First, FIG. 15 shows a conceptual rendering which expresses the physical connection sequence, processing details, and input/output data format of each device, in the case of recording only a specified ES within a service. Because this is the same configuration as described in the first embodiment, descriptions are hereby omitted.

Next, FIG. 25 shows a conceptual rendering which expresses the physical connection sequence, processing details, and input/output data format of each device, in the case where of an MPEG-2 transport stream that transports a service is recorded. Because this is the same configuration as described in the second embodiment, descriptions are hereby omitted.

Finally, FIG. 16 shows a conceptual rendering which expresses the physical connection sequence, processing details, and input/output data format of each device during recording of the service. Because this is the same configuration as described in the first embodiment, descriptions are hereby omitted.

Thus far, an example of a hardware configuration regarding the present invention has been described. Hereafter, a chief function of the present invention, which is control of recording and reproduction of the service via a Java program, is described.

In addition, FIG. 18 to FIG. 21 and FIG. 23, which are used in the first embodiment, are used again here to describe configurations of each type of data and a screen configuration used in the present embodiment; the AIT format shown in FIG. 30 of the fourth embodiment is also used here. Because the drawings are the same as described in the first and fourth embodiments, descriptions are hereby omitted.

A software configuration used in the present embodiment is configured as shown in FIG. 17 and FIG. 24. Regarding FIG. 17 and FIG. 24, constituent elements aside from the recorded service selection handler call unit 2405 and the recorded service selection unit 2404 are identical to those described in first embodiment, and therefore descriptions are omitted. In addition, the recorded service selection handler call unit 2405 is the same as described in the second embodiment, and thus descriptions are hereby omitted.

The recorded service selection unit 2404 of the present embodiment is a partly modified version of the recorded service selection unit 2404 of the second embodiment, and the method of providing a PMT when requesting, from the recorded service selection handler call unit 2405 and during recording operations, a call of a recorded service selection handler, differs from the second embodiment. Upon receiving a notification from the AIT monitoring unit 2405 of a new AIT the version of which has upgraded, or detecting an upgrade of the version of the PAT or the PMT, the recorded service selection unit 2404 first examines a simultaneous recording target channel identifier 3001 in the new AIT, the version of which has upgraded, received from the AIT monitoring unit 2402. With the exception of redundancies, the simultaneous recording target channel identifiers 3001 written in all Java programs denoted in the AIT are listed.

In the example of the AIT shown in FIG. 30, with the exception of redundancies, the simultaneous recording target channel identifiers are 1, 2, and 4. After that, the recorded service selection unit 2404 notifies the recorded service selection handler call unit 2405 of the newest AIT, the PMT corresponding to the simultaneous recording target channel identifier with the exception of redundancies, and the PMT of the service to be recorded, and requests a call of the recorded service selection handler. Then, as previously mentioned, the recorded service selection handler call unit 2405 returns the return value of a recording and reproduction handier notify method to the recorded service selection unit 2404. Processes following this are the same as those described in the second embodiment.

A characteristic operation of the present embodiment configured as described above is shown hereafter.

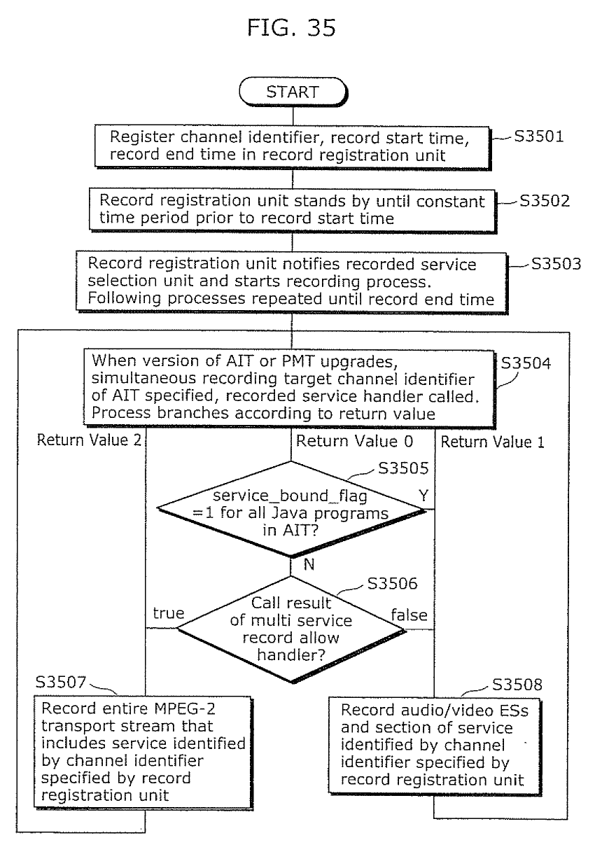

FIG. 35 is a flowchart showing an outline of a process when the service included in the broadcast wave is recorded into the secondary storage unit 1307, in the present embodiment.

In S3501, the Java program or an other program provides the channel identifier, record start time, and record end time to the record registration unit 2403. Then, moving to S3502, the record registration unit 2403 stands by until a constant time period prior to the specified record start time. After that, when the constant time period prior to the specified record start time is reached, the process moves to S3503, and the record registration unit 2403 requests the recorded service selection unit 2404 to commence the recording process. The recorded service selection unit 2404 repeats the following process until the specified record end time is reached.

When a version upgrade of the AIT or PMT, or an update of the PMT caused by a version upgrade of the PAT occurs, the process moves to S3504, and the recorded service selection unit 2404 examines the simultaneous recording target channel identifier if the AIT that includes the service to be recorded specified by the channel identifier, and determines the service to be simultaneously recorded. The recorded service selection unit 2404 specifies the service to be simultaneously recorded, and requests the recorded service selection handler call unit 2405 to call the notify method of the recorded service selection handler. The process branches in the following manner according to that return value.

If the return value is 2, the process moves to S3507, and all of the MPEG-2 transport stream that includes the service specified by the channel identifier, which in turn is specified by the record registration unit 2403, is recorded into the secondary storage unit 1307.

If the return value is 1, the process moves to S3550, and the video/audio ESs and section of only the service specified by the channel identifier, which in turn is specified by the record registration unit 2403, is recorded into the secondary storage unit 1307.

In the case where the return value is 0, the process moves to S3505, and a value of the service_bound_flag is examined for all the Java programs of the AIT of the service specified by the specified channel identifier. In the case where the service_bound_flag=1 for all the Java programs, the process moves to S3508, described earlier On the other hand, in the case where the service_bound_flag is not 1 for all the Java programs, the process moves to S3506, and the multi service record allow handler call unit 2407 is asked to call the AllowMultiServiceRec method of the multi service record allow handler. If that result is false, the process moves to the aforementioned S3508. However, if that result is true, the process moves to the aforementioned 53507.

When processing after each of the abovementioned branches finishes, the process returns to S3503, and the processing is repeated.

According to the present embodiment, in addition to the effects of the second embodiment, it is possible to selectively record only the service necessary for normal execution of the Java program, thus making possible normal execution of the Java program without wasteful consumption of space in the storage unit.

### Sixth Embodiment

Hereafter, an apparatus and a method according to the sixth embodiment of the present invention are described with reference to the drawings.

A hardware configuration used in the present embodiment is configured as shown in FIG. 26 and FIG. 14. As FIG. 26 has the same configuration and function as in the third embodiment, descriptions are omitted. Also, as FIG. 14 has the same configuration and function as in the first embodiment, descriptions are omitted.

In the present embodiment, each hardware constituent element has the following input and output setting.

First, FIG. 27 shows a conceptual rendering which expresses the physical connection sequence, processing details, and input/output data format of each device, in the case of recording only a specified ES within a service. Because this is the same configuration as described in the third embodiment, descriptions are hereby omitted.

Next, FIG. 28 shows a conceptual rendering which expresses the physical connection sequence, processing details, and input/output data format of each device during recording of the service. Because this is the same configuration as described in the third embodiment, descriptions are hereby omitted.

Thus far, an example of a hardware configuration regarding the present invention has been described. Hereafter, a chief function of the present invention, which is control of recording and reproduction of the service via a Java program, is described.

In addition, FIG. 18 to FIG. 20 and FIG. 23, which are used in the first embodiment, are used again here to describe configurations of each type of data and a screen configuration used in the present embodiment; the record information management table shown in FIG. 29 of the third embodiment and the AIT format shown in FIG. 30 of the fourth embodiment are also used here. Because the drawings are the same as described in the first, third, and fourth embodiments, descriptions are hereby omitted.

A software configuration used in the present embodiment is configured as shown in FIG. 17 and FIG. 24. Regarding FIG. 17 and FIG. 24, constituent elements aside from the application status management unit 2401, the AIT management unit 2402, and the recorded service selection unit 2404 are identical to those described in first embodiment, and therefore descriptions are omitted. In addition, because the application status management unit 2401 and the AIT management unit 2402 are the same as those described in the third embodiment, descriptions are hereby omitted.

The recorded service selection unit 2404 of the present embodiment is a partly modified version of the recorded service selection unit 2404 of the first embodiment. The process following i) receiving a notification from an AIT monitoring unit regarding a new AIT, the version of which has upgraded, during recording operations or ii) detecting a version upgrade of the PAT and the PMT differs from the first embodiment. At this time, the recorded service selection unit 2404 first examines the simultaneous recording target channel identifier 3001, in the new AIT, the version of which has upgraded, received from the AIT monitoring unit 2402.

With the exception of redundancies, the simultaneous recording target channel identifiers 3001 written in all lava programs denoted in the AIT are listed. In the example of the AIT shown in FIG. 30, with the exception of redundancies, the simultaneous recording target channel identifiers are 1, 2, and 4. After that, the recorded service selection unit 2404 notifies the recorded service selection handler call unit 2405 of the newest AIT, the PMT corresponding to the simultaneous recording target channel identifier with the exception of redundancies, and the PMT of the service to be recorded, and requests a call of the recorded service selection handler. Then, as previously mentioned, the recorded service selection handler call unit 2405 returns the return value of a recording and reproduction handler notify method to the recorded service selection unit 2404.

If a PMT array returns from the recorded service selection handier call unit 2405, a service group that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space.

Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the recording area 1504 that has been secured.

On the other hand, if null returns from the recorded service selection handler call unit 2405, the recorded service selection unit 2404 determines, through the following steps, the service to record simultaneously.

First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the recording area 1504 that has been secured.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records the service group specified by the simultaneous recording target channel identifier, with the exception of redundancies. In other words, all the ESs denoted in the PMT group that corresponds to the simultaneous recording target channel identifier, or in other words the audio, video, and all PIDs and table_ids of the section ES that make up the service related to the PMTs, are set in the PID filter 1502 and the section filter 1503 of the TS decoder.

However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 27, of recording the service included in the broadcast wave into the secondary storage unit 1307. Then, in accordance with the flow explained in FIG. 27, all ESs that make up a desired channel are recorded into the recording area 1504 that has been secured.

It is desirable to complete the pre-processing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 29 is created as management information of the MPEG-2 transport stream recorded earlier. Note that the AIT information management table part is merged with the table created by the section conversion unit 2401.

Processes aside from this are identical to those of the recorded service selection unit 2404 of the first embodiment.

A characteristic operation of the present embodiment configured as described above is shown hereafter.

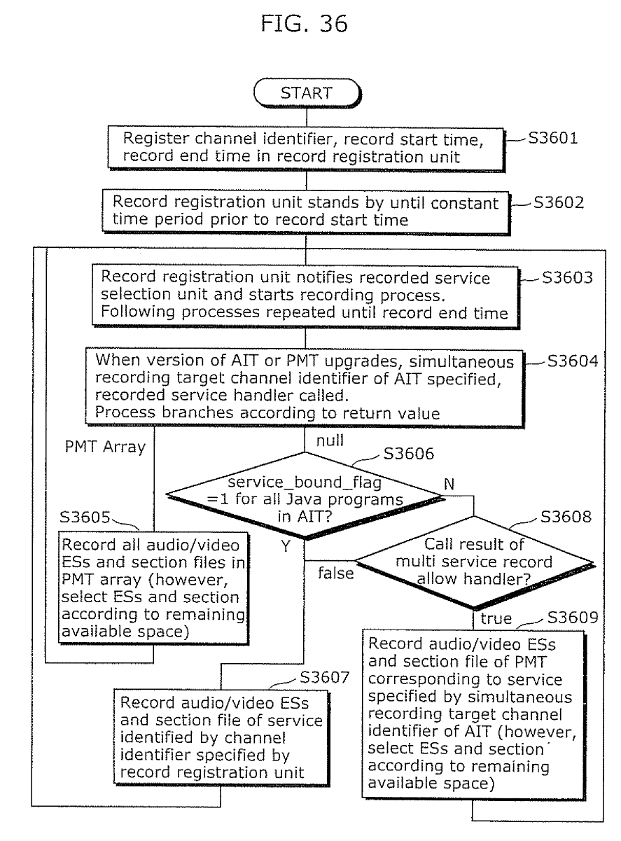

FIG. 36 is a flowchart showing an outline of a process when the service included in the broadcast wave is recorded into the secondary storage unit 1307, in the present embodiment.

In S3601, the Java program or an other program provides the channel identifier, record start time, and record end time to the record registration unit 2403. Then, moving to S3602, the record registration unit 2403 stands by until a constant time period prior to the specified record start time. After that, when the constant time period prior to the specified record start time is reached, the process moves to S3603, and the record registration unit 2403 requests the recorded service selection unit 2404 to commence the recording process. The recorded service selection unit 2404 repeats the following process until the specified record end time is reached.

When a version upgrade of the AIT or PMT or an update of the PMT caused by a version upgrade of the PAT occurs, the process moves to S3604, and the recorded service selection unit 2404 examines the simultaneous recording target channel identifier of the AIT that includes the service to be recorded specified by the channel identifier, and determines the service to be simultaneously recorded. The recorded service selection unit 2404 specifies the service to be simultaneously recorded, and requests the recorded service selection handier call unit 2405 to call the notify method of the recorded service selection handler. The process branches in the following manner according to that return value.

In the case where the return value is a PMT array, the process moves to S3605, and the recorded service selection unit 2404 records, into the secondary storage unit 1307, all the audio/video ESs and section files included in the PMT array, in accordance with the space remaining in the secondary storage unit 1307.

In the case where the return value is null, the process moves to S3606, and a value of the service_bound_flag is examined for all the Java programs of the AIT of the service specified by the specified channel identifier. In the case where the service_bound_flag=1 for all the Java programs, the process moves to S3607, and the video/audio ESs and section file of only the service specified by the channel identifier, which in turn is specified by the record registration unit 2403, is recorded into the secondary storage unit 1307.

On the other hand, in S3606, in the case where the service_bound_flag is not 1 for all the Java programs, the process moves to S3608. Here, the multi service record allow handler call unit 2407 is asked to call the AllowMultiServiceRec method of the multi service record allow handler. If that result is false, the process moves to the aforementioned S3607. On the other hand, if the result is true, the process moves to S3609, and the video/audio ESs and section files of all PMTs that correspond to the service to be simultaneous recorded are recorded into the secondary storage unit 1307, in accordance with the space remaining in the secondary storage unit 1307.

When processing after each of the abovementioned branches finishes, the process returns to S3603, and the processing is repeated.

According to the present embodiment, in addition to the effects of the third embodiment, only the service necessary for normal execution of the Java program is selectively recorded, thus making possible normal execution of the Java program without wasteful consumption of space in the storage unit.

### Seventh Embodiment

Hereafter, an apparatus and a method according to the seventh embodiment of the present invention are described with reference to the drawings.

A hardware configuration used in the present embodiment is configured as shown in FIG. 13 and FIG. 14. As this has the same configuration and function as in the first embodiment, descriptions are omitted.

In the present embodiment, each hardware constituent element has the following input and output setting.

First, FIG. 15 shows a conceptual rendering which expresses the physical connection sequence, processing details, and input/output data format of each device, in the case of recording only a specified ES within a service. Because this is the same configuration as described in the first embodiment, descriptions are hereby omitted.

Next, FIG. 16 shows a conceptual rendering which expresses the physical connection sequence, processing details, and input/output data format of each device during recording of the service. Because this is the same configuration as described in the first embodiment, descriptions are hereby omitted.

Thus far, an example of a hardware configuration regarding the present invention has been described. Hereafter, a chief function of the present invention, which is control of recording and reproduction of the service via a Java program, is described.

FIG. 18 to FIG. 23, which are used in the first embodiment, are used again here to describe configurations of each type of data and a screen configuration used in the present embodiment. Because constituent elements are the same as described in the first embodiment, descriptions are hereby omitted.

A software configuration used in the present embodiment is configured as shown in FIG. 17 and FIG. 24. Regarding FIG. 17 and FIG. 24, constituent elements aside from an AIT monitoring unit 2402 and a service selection unit 2404 are identical to those described in first embodiment, and therefore descriptions are omitted.

In addition to the functions of the AIT monitoring unit 2402 of the first embodiment, the AIT monitoring unit 2402 of the present embodiment monitors a version upgrade of all AIT included in an MPEG-2 transport stream. In other words, the version upgrade of the AIT is also monitored on channels aside from the specified channel identifier. This procedure is almost identical to the case of acquiring the AIT of the service that corresponds to the specified channel identifier. First, using the library 1701b, tuning information corresponding to the specified channel identifier is acquired. Next, using the SF 1704e, the PAT is acquired. The actual PMT of all PMTs referred to by this PAT are acquired, and referring to the details written within the actual PMTs, the PID of an elementary stream of a stream type “data” and with “AIT” as additional information is searched; section filtering is performed on this PID, and all actual AITs are acquired. Whenever the version of any of the AIT upgrades, the AIT monitoring unit 2402 outputs the entire newest AIT of all services within the MPEG-2 transport stream, to the recorded service selection unit 2404. Note that because there is the possibility that a version upgrade occurs for the PAT and the PMT, in the case where a version upgrade occurs for the PAT or the PMT, the AIT must be re-acquired and the version upgrade of the AIT must be checked.

The recorded service selection unit 2404 of the present embodiment is a partly modified version of the recorded service selection unit 2404 of the first embodiment, and the process following i) receiving a notification from an AIT monitoring unit regarding a new AIT, the version of which has upgraded, during recording operations or ii) detecting a version upgrade of the PAT and the PMT differs from the first embodiment. At this time, the recorded service selection unit 2404, first examines a service_bound_flag 2205 of a group of new AIT, the version of which has upgraded, received from the AIT monitoring unit 2402.

First, if there is no Java program in which the a service_bound_flag=0 in the AIT of the service specified by the recording channel identifier, which is in turn specified by the record registration unit 2403, it is determined that there is no service to be simultaneously recorded.

On the other hand, if there is even one Java program in which the service_bound_flag=0 in the AIT of the service specified by the recording channel identifier, the particular operation of service to be simultaneously recorded begins. In other words, all groups of the AIT outputted from the AIT monitoring unit 32402 are examined, and if there is even one Java program in which the service_bound_flag=0 within the AIT, the service that holds the AIT is the service to be simultaneously recorded.

After that, the recorded service selection unit 2404 notifies the recorded service selection handler call unit 2405 of the newest AIT, the group of the PMT corresponding to the service judged to be simultaneously recorded, and the PMT of the service to be recorded, and requests a call of the recorded service selection handler. Then, as previously mentioned, the recorded service selection handier call unit 2405 returns the return value of a recording and reproduction handler notify method to the recorded service selection unit 2404.

If a PMT array returns from the recorded service selection handler call unit 2405, a service group that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space.

Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow explained in FIG. 15, all ES that make up a desired channel are recorded into the recording area 1504 that has been secured.

On the other hand, if null returns from the recorded service selection handler call unit 2405, the recorded service selection unit 2404 determines, through the following steps, the service to record simultaneously.

First, the recorded service selection unit 2404 refers to the AIT of the service to be recorded specified by the record registration unit 2403, and examines a service_bound flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ES that make up a desired channel are recorded into the recording area 1504 that has been secured.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handler call unit 2407 returns false, the process described in the case where the service_bound_flag=1 is performed, and only the service to be recorded as specified by the channel identifier is recorded. In the case where the multi service record allow handler call unit 2407 returns true, all of the previously described services to be simultaneously recorded are recorded. In other words, all the ESs denoted in the PMT group that corresponds to the simultaneous recording target channel identifier, or in other words the audio, video, and all PIDs and table_ids of the section ES that make up the service related to the PMTs, are set in the PID filter 1502 and the section filter 1503 of the TS decoder.

However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 15, of recording the service included in the broadcast wave into the secondary storage unit 1307. Then, in accordance with the flow described in FIG. 15, all ES that make up a desired channel are recorded into the secured recording area 1504.

It is desirable to complete the pre-processing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 21 is created as management information of the MPEG-2 transport stream recorded earlier.

The processes aside from those mentioned above are the same as in the first embodiment.

A characteristic operation of the present embodiment configured as described above is shown hereafter.

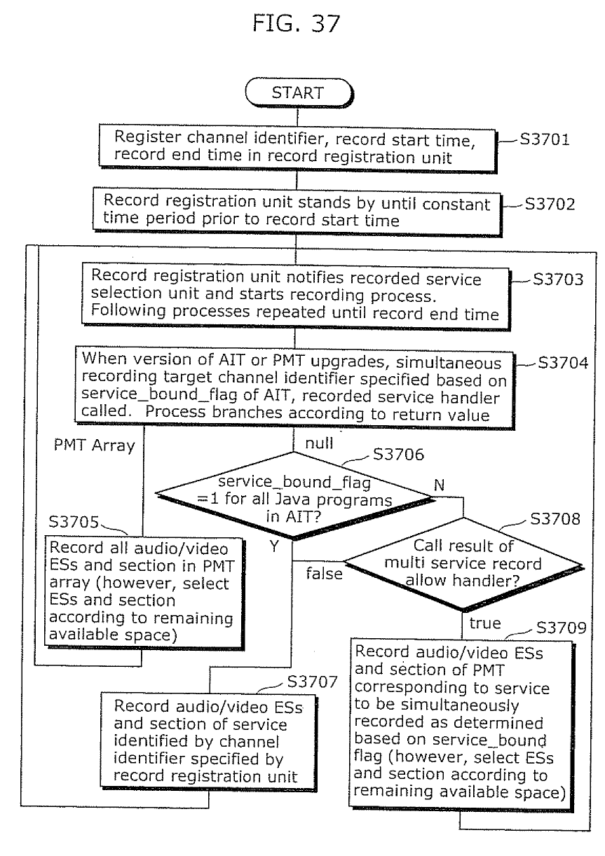

FIG. 37 is a flowchart showing an outline of a process when the service included in the broadcast wave is recorded into the secondary storage unit 1307, in the present embodiment.

In S3701, the Java program or an other program provides the channel identifier, record start time, and record end time to the record registration unit 2403. Then, moving to S3702, the record registration unit 2403 stands by until a constant time period prior to the specified record start time. After that, when the constant time period prior to the specified record start time is reached, the process moves to S3703, and the record registration unit 2403 requests the recorded service selection unit 2404 to commence the recording process. The recorded service selection unit 2404 repeats the following process until the specified record end time is reached.

When a version upgrade of the AIT or PMT or an update of the PMT caused by a version upgrade of the PAT occurs, the process moves to S3704, and the recorded service selection unit 2404 determines the service to be simultaneously recorded based on the service_bound_flag of the AIT that includes the service to be recorded specified by the channel identifier. The recorded service selection unit 2404 specifies the service to be simultaneously recorded, and requests the recorded service selection handler call unit 2405 to call the notify method of the recorded service selection handler. The process branches in the following manner according to that return value.

In the case where the return value is a PMT array, the process moves to S3705, and the recorded service selection unit 2404 records, into the secondary storage unit 1307, all the audio/video ESs and sections included in the PMT array, in accordance with the space remaining in the secondary storage unit 1307.

In the case where the return value is null, the process moves to S3706, and a value of the service_bound_flag is examined for all the Java programs of the AIT of the service specified by the specified channel identifier. In the case where the service_bound_flag=1 for all the Java programs, the process moves to S3707, and the video/audio ESs and section of only the service specified by the channel identifier, which in turn is specified by the record registration unit 2403, is recorded into the secondary storage unit 1307.

On the other hand, in S3706, in the case where the service_bound_flag is not 1 for all the Java programs, the process moves to S3708. Here, multi service record allow handler call unit 2407 is requested to call the AllowMultiServiceRec method of the multi service record allow handler. If that result is false, the process moves to the aforementioned S3707. On the other hand, if the result is true, the process moves to S3709, and the video/audio ESs and section of all PMTs that correspond to the service to be simultaneous recorded are recorded into the secondary storage unit 1307, in accordance with the space remaining in the secondary storage unit 1307.

When processing after each of the abovementioned branches finishes, the process returns to S3703, and the processing is repeated.

According to the present embodiment, in addition to the effects of the first embodiment, it is possible to selectively record only the service necessary for normal execution of the Java program, thus making possible normal execution of the Java program without wasteful consumption of space in the storage unit.

### Eighth Embodiment

Hereafter, an apparatus and a method according to the eighth embodiment of the present invention are described with reference to the drawings.

A hardware configuration used in the present embodiment is configured as shown in FIG. 13 and FIG. 14. As this has the same configuration and function as in the first embodiment, descriptions are omitted.

In the present embodiment, each hardware constituent element has the following input and output setting.

First, FIG. 15 shows a conceptual rendering which expresses the physical connection sequence, processing details, and input/output data format of each device, in the case of recording only a specified ES within a service. Because this is the same configuration as described in the first embodiment, descriptions are hereby omitted.

Next, FIG. 25 shows a conceptual rendering which expresses the physical connection sequence, processing details, and input/output data format of each device, in the case where of an MPEG-2 transport stream that transports a service is recorded. Because this is the same configuration as described in the second embodiment, descriptions are hereby omitted.

Finally, FIG. 16 shows a conceptual rendering which expresses the physical connection sequence, processing details, and input/output data format of each device during recording of the service. Because this is the same configuration as described in the first embodiment, descriptions are hereby omitted.

Thus far, an example of a hardware configuration regarding the present invention has been described. Hereafter, a chief function of the present invention, which is control of recording and reproduction of the service via a Java program, is described.

FIG. 18 to FIG. 23, which are used in the first embodiment, are used again here to describe configurations of each type of data and a screen configuration used in the present embodiment. Because constituent elements are the same as described in the first embodiment, descriptions are hereby omitted.

A software configuration used in the present embodiment is configured as shown in FIG. 17 and FIG. 24. Regarding FIG. 17 and FIG. 24, constituent elements aside from the AIT monitoring unit 2402, the recorded service selection handler call unit 2405, and the recorded service selection unit 2404 are identical to those described in the first embodiment, and therefore descriptions are omitted. In addition, the recorded service selection handler call unit 2405 is the same as described in the second embodiment, and thus descriptions are hereby omitted. The AIT monitoring unit 2402 is the same as that described in the seventh embodiment, and therefore descriptions are omitted.

The recorded service selection unit 2404 of the present embodiment is a partly modified version of the recorded service selection unit 2404 of the second embodiment, and the method of providing a PMT when requesting, from the recorded service selection handler call unit 2405 and during recording operations, a call of a recorded service selection handler, differs from the second embodiment. At this time, the recorded service selection unit 2404, first examines a service_bound_flag 2205 of a group of new AIT (the version of which has upgraded, received from the AIT monitoring unit 2402.

If there is no lava program in which the service_bound_flag=0 in the AIT of the service specified by the recording channel identifier, which is in turn specified by the record registration unit 2403, it is determined that there is no service to be simultaneously recorded.

On the other hand, if there is even one Java program in which the service_bound_flag=0 in the AIT of the service specified by the recording channel identifier, the particular operation of service to be simultaneously recorded begins. In other words, all groups of the AIT outputted from the AIT monitoring unit 32402 are examined, and if there is even one Java program in which the service_bound_flag=0 within the AIT, the service that holds the AIT is the service to be simultaneously recorded.

After that, the recorded service selection unit 2404 notifies the recorded service selection handler call unit 2405 of the newest AIT, the group of the PMT corresponding to the service judged to be simultaneously recorded, and the PMT of the service to be recorded, and requests a call of the recorded service selection handler. Then, as previously mentioned, the recorded service selection handler call unit 2405 returns the return value of a recording and reproduction handler notify method to the recorded service selection unit 2404. Processes following this are the same as those described in the second embodiment.

A characteristic operation of the present embodiment configured as described above is shown hereafter.

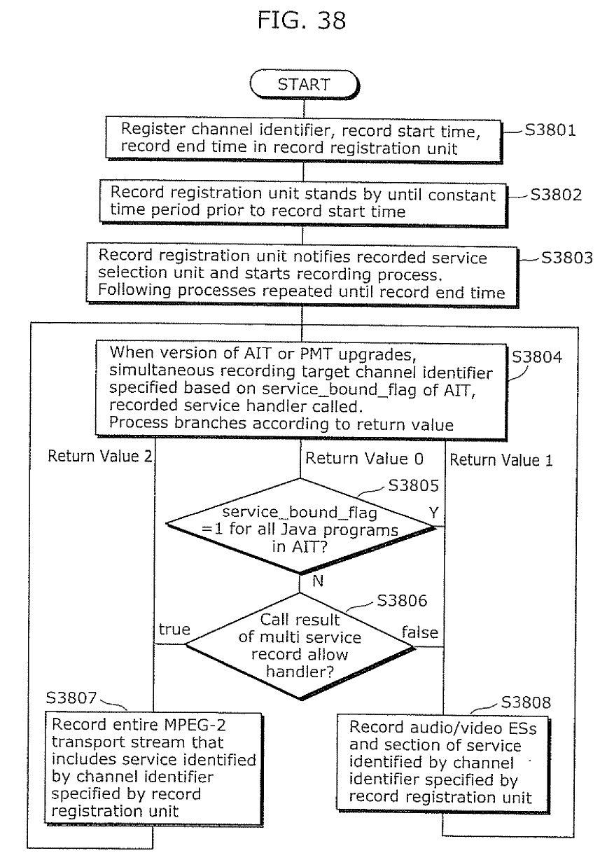

FIG. 38 is a flowchart showing an outline of a process when the service included in the broadcast wave is recorded into the secondary storage unit 1307, in the present embodiment.

In S3801, the Java program or an other program provides the channel identifier, record start time, and record end time to the record registration unit 2403. Then, moving to S3802, the record registration unit 2403 stands by until a constant time period prior to the specified record start time. After that, when the constant time period prior to the specified record start time is reached, the process moves to S3803, and the record registration unit 2403 requests the recorded service selection unit 2404 to commence the recording process. The recorded service selection unit 2404 repeats the following process until the specified record end time is reached.

When a version upgrade of the AIT or PMT or an update of the PMT caused by a version upgrade of the PAT occurs, the process moves to S3804, and the recorded service selection unit 2404 determines the service to be simultaneously recorded based on the service_bound_flag of the AIT that includes the service to be recorded specified by the channel identifier. The recorded service selection unit 2404 specifies the service to be simultaneously recorded, and requests the recorded service selection handler call unit 2405 to call the notify method of the recorded service selection handler. The process branches in the following manner according to that return value.

If the return value is 2, the process moves to S3807, and all of the MPEG-2 transport stream that includes the service specified by the channel identifier, which in turn is specified by the record registration unit 2403, is recorded into the secondary storage unit 1307.

If the return value is 1, the process moves to S3808, and the video/audio ESs and section of only the service specified by the channel identifier, which in turn is specified by the record registration unit 2403, is recorded into the secondary storage unit 1307.

In the case where the return value is 0, the process moves to S3805, and a value of the service_bound_flag is examined for all the Java programs of the AIT of the service specified by the specified channel identifier. In the case where the service_bound_flag=1 for all the Java programs, the process moves to S3808, described earlier.

On the other hand, in the case where the service_bound_flag is not 1 for all the Java programs, the process moves to S3806, and the multi service record allow handler call unit 2407 is asked to call the AllowMultiServiceRec method of the multi service record allow handler. If that result is false, the process moves to the aforementioned 53808. However, if that result is true, the process moves to the aforementioned 53807.

When processing after each of the abovementioned branches finishes, the process returns to S3803, and the processing is repeated.

According to the present embodiment, in addition to the effects of the second embodiment, it is possible to selectively record only the service assumed to be necessary for normal execution of the Java program, thus making possible normal execution of the Java program without wasteful consumption of space in the storage unit.

### Ninth Embodiment

Hereafter, an apparatus and a method according to the ninth embodiment of the present invention are described with reference to the drawings.

A hardware configuration used in the present embodiment is configured as shown in FIG. 26 and FIG. 14. As FIG. 26 has the same configuration and function as in the third embodiment, descriptions are omitted. As FIG. 14 has the same configuration and function as in the first embodiment, descriptions are omitted. In the present embodiment, each hardware constituent element has the following input and output setting.

First, FIG. 27 shows a conceptual rendering which expresses the physical connection sequence, processing details, and input/output data format of each device, in the case of recording only a specified ES within a service. Because this is the same configuration as described in the third embodiment, descriptions are hereby omitted.

Next, FIG. 28 shows a conceptual rendering which expresses the physical connection sequence, processing details, and input/output data format of each device during recording of the service. Because this is the same configuration as described in the third embodiment, descriptions are hereby omitted.

Thus far, an example of a hardware configuration regarding the present invention has been described. Hereafter, a chief function of the present invention, which is control of recording and reproduction of the service via a Java program, is described.

FIG. 18 to FIG. 21 and FIG. 23, which are used in the first embodiment, are used again here to describe configurations of each type of data and a screen configuration used in the present embodiment; the AIT format shown in FIG. 30 of the fourth embodiment is also used here. Because the drawings are the same as described in the first and fourth embodiments, descriptions are hereby omitted.

A software configuration used in the present embodiment is configured as shown in FIG. 17 and FIG. 24. Regarding FIG. 17 and FIG. 24, constituent elements aside from the AIT monitoring unit 2402, the recorded service selection handler call unit 2405, and the recorded service selection unit 2404 are identical to those described in the first embodiment, and therefore descriptions are omitted. In addition, the recorded service selection handler call unit 2405 is the same as described in the second embodiment, and thus descriptions are hereby omitted. The AIT monitoring unit 2402 is the same as that described in the seventh embodiment, and therefore descriptions are omitted.

The recorded service selection unit 2404 of the present embodiment is a partly modified version of the recorded service selection unit 2404 of the first embodiment, and the method of providing a PMT when requesting, from the recorded service selection handler call unit 2405 and during recording operations, a call of a recorded service selection handler, differs from the first embodiment. At this time, the recorded service selection unit 2404, first examines a service_bound_flag 2205 of a group of new AIT, the version of which has upgraded, received from the AIT monitoring unit 2402.

If there is no Java program in which the service_bound_flag=0 in the AIT of the service specified by the recording channel identifier, which is in turn specified by the record registration unit 2403, it is determined that there is no service to be simultaneously recorded.

On the other hand, if there is even one Java program in which the service_bound_flag=0 in the AIT of the service specified by the recording channel identifier, the particular operation of the service to be simultaneously recorded begins. In other words, all groups of the AIT outputted from the AIT monitoring unit 32402 are examined, and if there is even one lava program in which the service_bound_flag=0 within the AIT, the service that holds the AIT is the service to be simultaneously recorded.

After that, the recorded service selection unit 2404 notifies the recorded service selection handler call unit 2405 of the newest AIT, the group of the PMT corresponding to the service judged to be simultaneously recorded, and the PMT of the service to be recorded, and requests a call of the recorded service selection handler. Then, as previously mentioned, the recorded service selection handler call unit 2405 returns the return value of a recording and reproduction handler notify method to the recorded service selection unit 2404.

If a PMT array returns from the recorded service selection handler call unit 2405, a service group that the specified PMT expresses is recorded simultaneously. All the ESs denoted in the PMT array, or in other words the audio, video, and all PIDs and table_ids of the section ES that make up the service related to all PMTs, are set in the PID filter 1502 and the section filter 1503 of the TS decoder. However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space.

Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the recording area 1504 that has been secured.

On the other hand, if null returns from the recorded service selection handler call unit 2405, the recorded service selection unit 2404 determines, through the following steps, the service to record simultaneously.

First, the recorded service selection unit 2404 refers to the AIT, and examines a service_bound_flag of all Java programs included in the service.

If the service_bound_flag=1 for all Java programs, the recorded service selection unit 2404 records only the service to be recorded as specified by the channel identifier. In other words, all the ESs denoted in the PMT of the service to be recorded, or in other words the audio, video, and all PIDs and table_ids of the section ES that make up the service, are set in the PID filter 1502 and the section filter 1503 of the TS decoder. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ES that make up a desired channel are recorded into the secured recording area 1504.

On the other hand, in the case where there is a Java program in which the service_bound_flag=0, the recorded service selection unit 2404 requests the multi service record allow handler call unit 2407 for a judgment of whether or not to allow recording of multiple services. In the case where the multi service record allow handier call unit 2407 returns false, the process described in the case where the service_bound_flag=1 is performed, and only the service to be recorded as specified by the channel identifier is recorded. In the case where the multi service record allow handler call unit 2407 returns true, the recorded service selection unit 2404 records all the services specified by the simultaneous recording target channel identifier, with the exception of redundancies. In other words, all the ESs denoted in the PMT group that corresponds to the simultaneous recording target channel identifier, or in other words the audio, video, and all PIDs and table_ids of the section ES that make up the service related to the PMTs, are set in the PID filter 1502 and the section filter 1503 of the TS decoder.

However, in the case where there is little remaining space in the secondary storage unit 1307, only a part of the audio/video ES and section is recorded, in accordance with that remaining space. In other words, the recorded service selection unit 2404 examines the space remaining in the secondary storage unit 1307 through the library 1701b, and sets the PID filter 1502 and the section filter 1503 of the TS decoder to record, into the secondary storage unit 1307, only the audio/video ES and section that can be recorded into that remaining space. Determination of the required space may be carried out with an arbitrary algorithm. For example, a bit rate of the audio/video ES is written in the stream, and can be fetched by the library 1701b. There is a method in which the amount of space necessary for recording is calculated from the bit rate and a recording time, and a service in which at least the audio/video ES cannot be recorded is not recorded. After that, an output destination of each hardware constituent element is set through the library 1701b so as to follow the process, shown in FIG. 27, of recording the service included in the broadcast wave into the secondary storage unit 1307. Then, in accordance with the flow described in FIG. 27, all ESs that make up a desired channel are recorded into the secured recording area 1504.

It is desirable to complete the pre-processing that occurs before recording actually takes place, as described above, prior to the specified record start time. Actually recording in the recording area 1504 occurs after the specified start time.

After that, when the specified record end time is reached, the recorded service selection unit 2404 stops the tuning process of the Tuner 1704c, and causes the writing of the MPEG-2 transport stream to the recording area 1504 to end. In addition, a record information management table as shown in FIG. 29 is created as management information of the MPEG-2 transport stream recorded earlier. Note that the AIT information management table part is merged with the table created by the section conversion unit 2401.

Processes aside from this are the same as with the application status management unit in the first embodiment.

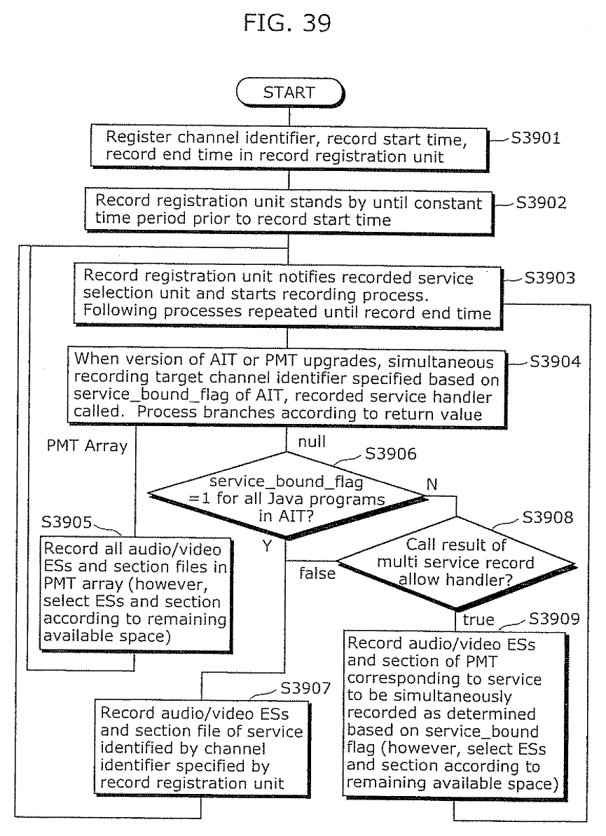

A characteristic operation of the present embodiment configured as described above is shown hereafter FIG. 39 is a flowchart showing an outline of a process when the service included in the broadcast wave is recorded into the secondary storage unit 1307, in the present embodiment.

In S3901, the Java program or an other program provides the channel identifier, record start time, and record end time to the record registration unit 2403. Then, moving to S3902, the record registration unit 2403 stands by until a constant time period prior to the specified record start time. After that, when the constant time period prior to the specified record start time is reached, the process moves to S3903, and the record registration unit 2403 requests the recorded service selection unit 2404 to commence the recording process. The recorded service selection unit 2404 repeats the following process until the specified record end time is reached.

When a version upgrade of the AIT or PMT or an update of the PMT caused by a version upgrade of the PAT occurs, the process moves to S3904, and the recorded service selection unit 2404 determines the service to be simultaneously recorded based on the service_bound_flag of the AIT that includes the service to be recorded specified by the channel identifier. The recorded service selection unit 2404 specifies the service to be simultaneously recorded, and requests the recorded service selection handler call unit 2405 to call the notify method of the recorded service selection handler. The process branches in the following manner according to that return value.

In the case where the return value is a PIT array, the process moves to S3905, and the recorded service selection unit 2404 records, into the secondary storage unit 1307, all the audio/video ESs and sections included in the PMT array, in accordance with the space remaining in the secondary storage unit 1307.

In the case where the return value is null, the process moves to S3906, and a value of the service_bound_flag is examined for all the Java programs of the AIT of the service specified by the specified channel identifier. In the case where the service_bound_flag=1 for all the Java programs, the process moves to S3907, and the video/audio ESs and section of only the service specified by the channel identifier, which in turn is specified by the record registration unit 2403, is recorded into the secondary storage unit 1307.

On the other hand, in S3906, in the case where the service_bound_flag is not 1 for all the Java programs, the process moves to S3908, Here, the multi service record allow handier call unit 2407 is asked to call the AllowMultiServiceRec method of the multi service record allow handier. If that result is false, the process moves to the aforementioned S3907. On the other hand, if the result is true, the process moves to S3909, and the video/audio ESs and section of all PMTs that correspond to the service to be simultaneous recorded are recorded into the secondary storage unit 1307, in accordance with the space remaining in the secondary storage unit 1307.

When processing after each of the abovementioned branches finishes, the process returns to S3903, and the processing is repeated.

According to the present embodiment, in addition to the effects of the third embodiment, it is possible to selectively record only the service necessary for normal execution of the Java program, thus making possible normal execution of the Java program without wasteful consumption of space in the storage unit.

Some of the embodiments described above indicate embodiments of the present invention, but other embodiments can be considered without deviating from the scope of the present invention. In addition, a configuration may be one in which main processes of each embodiment are selected and combined. It is possible to replace parts of the above description that are implemented by software with hardware and vice versa.

In the description of the embodiments, the simultaneous recording channel identifier is written per Java program, but the simultaneous recording channel identifier may be written as a list in the AIT as a list of simultaneous recording channel identifiers necessary for reproduction of the service, with the exception of redundancies.

The method Handler.allowMultiServiceRec( ) of the multi service record allow handler may take on a configuration in which it supplies, as a parameter, a parameter identical to that of the method Handler.notify (AITait, PMTpmt, PMTpmt [ ]) of the recorded service selection handler; or in other words, a configuration in which it supplies the AIT, the PMT of the service to be recorded, the PMT of the service to be simultaneously recorded, and the like. In such a case, because the multi service record allow handler can obtain information regarding a service scheduled to be recorded, a more appropriate circumstantial judgment is possible. In addition, these method parameters are not limited to the AIT and the PMT, but may be anything as long as information regarding the service to be recorded and the service to be simultaneously recorded can be obtained.

In the embodiments, a configuration for a cable system has been shown, but the present invention can be applied independent of the type of broadcast system. For example, the present invention can easily be applied to a satellite system, a ground wave system, or a TV show distribution system that uses an IP network.

In addition, as the present invention has no direct relationship with the differences between each broadcast system, the present invention can be applied to an arbitrary transmission medium regardless of the broadcast system. The present invention is also applicable regardless of whether the system is a wired or wireless system.

It is not necessary for the AV decoder to decode video and audio at the same time. The present invention can be implemented even if the AV decoder is configured as separate video and audio decoders. In addition, the AV decoder may have a decode function for data such as closed captioning and the like without any interference. The audio signal and video signal decoded by the AV decoder may be scrambled at any stage up until being stored in the recording area 1504.

In the embodiments, an example is given in which an adapter that controls conditional access has been introduced, but the adapter is not necessary for the implementation of the present invention. The adapter may be of any format, and a configuration without the adapter is also possible. In such a case, in FIG. 15, the MPEG-2 transport stream from the tuner is inputted directly into the TS decoder. The present invention is applicable in such a case as well. In addition, releasing of the conditional access by the adapter does not necessarily have to be carried out before the TS decoder. A configuration in which the adapter is in an arbitrary position and is used to release the conditional access can easily be implemented, and the present invention is applicable in such a case as well.

An encoding format into which the AV encoder encodes the audio and video signal may be an arbitrary format. The present invention is applicable regardless of the encoding format.

A multiplexing format of the multiplexer may also be an arbitrary format. The present invention is applicable regardless of the multiplexing format.

The display and the speaker may be contained within the broadcast recording and reproduction apparatus, or an external display and speaker may be connected to the broadcast recording and reproduction apparatus. The present invention is applicable regardless of the location and number of the display and speaker.

The present invention can be implemented even if the CPU itself is a system which performs multiple processes, the processes being all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU and pass the resultant to the CPU, which executes it; the present invention is applicable in such a case as well.

The above embodiments describe a method for implementation regarding the AIT in which the transport stream is obtained from in-band; however, the method for referring to the Java program which the AM shall execute does not solely depend on the AIT. In OCAP, which is assumed as being used in United States cable systems, XAIT, which is identical to AIT and transmits synchronous data OOB, is used. In addition, methods such as starting a program pre-recorded in the ROM, starting a program downloaded and recorded in the secondary storage unit, and so on can be considered.

A method for recording the DSM-CC file system and the AIT file may be an arbitrary method.

The present invention can be implemented even if a method in which the AIT section is filtered and acquired from the MPEG-2 transport stream and a method in which the DSM-CC section is recorded in a file in a unique format are combined. In addition, the present invention can be implemented even if a method in which the DSM-CC section is filtered and acquired from the MPEG-2 transport stream and a method in which the AIT section is recorded in a file in a unique format are combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A recording and reproduction apparatus and recording and reproduction method according to the present invention can be applied in the consumer electronics industry as an apparatus for recording and reproducing a broadcast. For example, the present invention is applicable to cable STB, digital TV, and the like. Furthermore, the present invention is also applicable in devices with a broadcast receiving function, such as, for example, a cellular phone device and the like.

1. A recording and reproduction apparatus comprising:
a receiving unit operable to receive plural services, each including video information, audio information, a program, synchronization information for synchronizing the video information and the audio information with the program, and service element identification information for identifying the video information, audio information, program, and synchronization information;
a recording unit operable to record, into a recording medium, a specified predetermined service, from among the received plural services;
a reproduction unit operable to reproduce video information and audio information included in the received predetermined service or the predetermined service recorded in the recording medium; and
a program execution unit operable to execute a program included in the received predetermined service or the predetermined service recorded in the recording medium,
wherein said recording and reproduction apparatus:
reproduces the video information and the audio information included in the predetermined service recorded in the recording medium in synchronization with the program included in the predetermined service, by executing the program included in the predetermined service in accordance with the synchronization information;
reacquires the service element identification information corresponding to the specified predetermined service among the received plural services in the case where an update of the synchronization information or the service element identification information occurs while said recording unit is recording the predetermined service; and
isolates the specified predetermined service based on the acquired service element identification information, and causes said recording unit to record the isolated service.

2. The recording and reproduction apparatus according to claim 1,
wherein said recording and reproduction apparatus:
reacquires the service element identification information corresponding to the specified predetermined service among the received plural services in the case where an update of the synchronization information or the service element identification information occurs while said recording unit is recording; and
isolates the specified predetermined service based on the acquired service element identification information, and causes said recording unit to record video information, audio information, a program, the synchronization information, and the service element identification information included in the isolated service.

3. The recording and reproduction apparatus according to claim 1,
wherein said recording and reproduction apparatus:
reacquires the service element identification information corresponding to the specified predetermined service among the received plural services in the case where an update of the synchronization information or the service element identification information occurs while said recording unit is recording; and
isolates the specified predetermined service based on the acquired service element identification information, and causes said recording unit to record a transport stream corresponding to the isolated service.

4. The recording and reproduction apparatus according to claim 1,
wherein a program included in a specified first service that is to be recorded is also included in a second service;
the synchronization information includes continuous execution information indicating whether or not it is possible to continue executing the program included in the first service when the first service is switched, during reproduction, to the second service, and the second service is reproduced; and
said recording and reproduction apparatus isolates, as the predetermined service, the second service in addition to the specified first service, based on the acquired service element identification information, and causes said recording unit to record the isolated service, in the case where the continuous execution information included in the synchronization information corresponding to the program included in the first service indicates that it is possible to continue executing the program even when the second service is switched to and the second service is reproduced.

5. The recording and reproduction apparatus according to claim 1,
wherein said recording and reproduction apparatus isolates, as the predetermined service, the second service in addition to the specified first service, based on the acquired service element identification information, and causes said recording unit to record the isolated service, only in the case where simultaneous recording of the first service and the second service can be allowed.

6. A recording and reproduction apparatus comprising:
a receiving unit operable to receive plural services, each including video information, audio information, a program, synchronization information for synchronizing the video information and the audio information with the program, and service element identification information for identifying the video information, audio information, program, and synchronization information;
a recording unit operable to record, into a recording medium, a specified first service among the received plural services;
a reproduction unit operable to reproduce video information and audio information included in the received first service or the first service recorded in the recording medium; and
a program execution unit operable to execute a program included in the received first service or the first service recorded in the recording medium,
wherein said recording and reproduction apparatus reproduces the video information and the audio information included in the first service recorded in the recording medium in synchronization with the program included in the first service, by executing the program included in the first service in accordance with the synchronization information;
the program included in the first service that is specified to be recorded is also included in a second service;
the synchronization information includes continuous execution information indicating whether or not it is possible to continue executing the program included in the first service when the first service is switched, during reproduction, to the second service, and the second service is reproduced; and
said recording and reproduction apparatus isolates, as the predetermined service, the second service in addition to the specified first service, based on the acquired service element identification information, and causes said recording unit to record the isolated service, in the case where the continuous execution information included in the synchronization information corresponding to the program included in the first service indicates that it is possible to continue executing the program even when the second service is switched to and the second service is reproduced.

7. The recording and reproduction apparatus according to claim 6,
wherein the program included in the first service that is specified to be recorded is also included in a second service;
the synchronization information includes continuous execution information indicating whether or not it is possible to continue executing the program included in the first service when the first service is switched, during reproduction, to the second service, and the second service is reproduced; and
said recording and reproduction apparatus isolates, as the predetermined service, the second service in addition to the specified first service, based on the acquired service element identification information, and causes said recording unit to record a transport stream corresponding to the isolated service, in the case where the continuous execution information included in the synchronization information corresponding to the program included in the first service indicates that it is possible to continue executing the program even when the second service is switched to and the second service is reproduced.

8. The recording and reproduction apparatus according to claim 7,
wherein said recording and reproduction apparatus isolates, as the predetermined service, the second service in addition to the specified first service, based on the acquired service element identification information, and causes said recording unit to record the transport stream corresponding to the isolated service, only in the case where simultaneous recording of the first service and the second service can be allowed.

9. The recording and reproduction apparatus according to claim 1,
wherein said recording unit converts a file format of a service into another format, in the case of recording a service into the recording medium, and records a validity period of the file along with the service.

10. The recording and reproduction apparatus according to claim 1,
wherein said recording unit recommences recording of the service each time the synchronization information or the service element identification information is updated.

11. A recording and reproduction apparatus comprising:
a receiving unit operable to receive plural services, each including video information, audio information, a program, synchronization information for synchronizing the video information and the audio information with the program, and service element identification information for identifying the video information, audio information, program, and synchronization information;
a recording unit operable to record, into a recording medium, a specified predetermined service among the received plural services;
a reproduction unit operable to reproduce video information and audio information included in the received predetermined service or the predetermined service recorded in the recording medium; and
a program execution unit operable to execute a program included in the received predetermined service or the predetermined service recorded in the recording medium,
wherein said recording and reproduction apparatus:
reproduces the video information and the audio information included in the predetermined service recorded in the recording medium in synchronization with the program included in the predetermined service, by executing the program included in the predetermined service in accordance with the synchronization information;
reacquires the synchronization information corresponding to the specified predetermined service among the received plural services in the case where an update of the synchronization information or the service element identification information occurs while said recording unit is recording the predetermined service; and
isolates the specified predetermined service based on the acquired synchronization information, and causes said recording unit to record the isolated service.

12. The recording and reproduction apparatus according to claim 11,
wherein the synchronization information includes simultaneous recording information indicating a second service to be recorded at the same time in the case where a first service specified to be recorded is recorded, and continuous execution information indicating whether or not it is possible to continue executing a program included in the first service when the first service is switched, during reproduction, to the second service, and the second service is reproduced; and
said recording and reproduction apparatus isolates, as the predetermined service, the second service in addition to the specified first service, based on the simultaneous recording information included in the acquired synchronization information, and causes said recording unit to record the isolated service, in the case where the continuous execution information included in the synchronization information corresponding to the program included in the first service indicates that it is possible to continue executing the program even when the second service is switched to and the second service is reproduced.

13. The recording and reproduction apparatus according to claim 12,
wherein said recording and reproduction apparatus isolates, as the predetermined service, the second service in addition to the specified first service, based on the simultaneous recording information included in the acquired synchronization information, and causes said recording unit to record the isolated service, only in the case where simultaneous recording of the first service and the second service can be allowed.

14. The recording and reproduction apparatus according to claim 11,
wherein said recording and reproduction apparatus isolates the specified predetermined service based on the simultaneous recording information included in the acquired synchronization information, and causes said recording unit to record video information, audio information, a program, the synchronization information, and the service element identification information included in the isolated service.

15. The recording and reproduction apparatus according to claim 11,
wherein said recording and reproduction apparatus isolates the specified predetermined service based on the acquired synchronization information, and causes said recording unit to record a transport stream corresponding to the isolated service.

16. The recording and reproduction apparatus according to claim 11,
wherein said recording unit converts a file format of a service into another format, in the case of recording a service into the recording medium, and records a validity period of the file along with the service.

17. The recording and reproduction apparatus according to claim 11,
wherein said recording unit recommences recording of the service each time the synchronization information or the service element identification information is updated.

18. The recording and reproduction apparatus according to claim 11,
wherein the synchronization information includes continuous execution information indicating whether or not it is possible to continue executing the program included in the first service when the first service is switched, during reproduction, to the second service, and the second service is reproduced, and
said recording and reproduction apparatus:
reacquires the synchronization information corresponding to the specified predetermined service among the received plural services in the case where an update of the synchronization information or the service element identification information occurs while said recording unit is recording the predetermined service; and
isolates the specified predetermined service based on the continuous execution information included in the acquired synchronization information, and causes said recording unit to record the isolated service.

19. The recording and reproduction apparatus according to claim 12,
wherein said recording and reproduction apparatus isolates the specified predetermined service based on the simultaneous recording information included in the acquired synchronization information, and causes said recording unit to record the video information, audio information, program, synchronization information, and service element identification information included in the isolated service.

20. The recording and reproduction apparatus according to claim 11,
wherein said recording and reproduction apparatus isolates the specified predetermined service based on the acquired synchronization information, and causes said recording unit to record a transport stream corresponding to the isolated service.
